(19) United States
(12) Patent Application Publication
(10) Pub. No.: US 2026/0118636 A1
(43) Pub. Date: Apr. 30, 2026

(54) IMAGING OPTICAL SYSTEM

(71) Applicant: SIGMA CORPORATION, Kanagawa (JP)

(72) Inventor: Yukihiro YAMAMOTO, Fukuoka (JP)

(73) Assignee: SIGMA CORPORATION, Kanagawa (JP)

(21) Appl. No.: 19/338,031

(22) Filed: Sep. 24, 2025

(30) Foreign Application Priority Data
Oct. 31, 2024 (JP) 2024-191301

(51) Int. Cl. G02B 13/00; G02B 7/02

(52) U.S. Cl. CPC G02B 13/0045; G02B 7/025; G02B 13/006

(57) ABSTRACT

Provided is an imaging optical system that achieves both a large aperture ratio and favorable aberration correction in consideration of weight reduction of a focus lens that is mainly driven in focusing, in response to a large-sized imaging element. The imaging optical system includes, in order from an object side: a first lens group Gr1; a second lens group Gr2 that has a positive refractive power; a third lens group Gr3; a fourth lens group Gr4 that has a positive refractive power; and a fifth lens group Gr5 that has a negative refractive power. During focusing from infinity to a short distance, the second lens group Gr2 and the fourth lens group Gr4 move toward the object side along the same path on an optical axis, and a predetermined conditional expression is satisfied.

### TECHNICAL FIELD

The present invention relates to an imaging optical system suitable for an imaging lens used in an imaging apparatus such as a still camera or a video camera.

### BACKGROUND ART

In recent years, cameras employing large-sized imaging elements have been widespread in imaging apparatuses such as digital still cameras and video cameras.

In addition, a lens having a large aperture ratio is desired in order to obtain a large blurred image and to use a high-speed shutter. On the other hand, in the case of the auto focus or the video capturing, it is desirable to reduce the weight of the lens used for focusing in order to reduce the load on the actuator. However, in a case where the aperture ratio of the lens is increased, the lens used for focusing is also increased in size, and the burden on the actuator and the control of the actuator is increased. In particular, in a telephoto lens having a large aperture ratio, the lens diameter tends to increase, so it is an important issue to reduce the weight of the lens for focusing.

### RELATED ART DOCUMENT

### Patent Document

[Patent Document 1] JP2023-009759 A
[Patent Document 2] International Publication WO2021/220579
[Patent Document 3] International Publication WO2019/187633
[Patent Document 4] JP2021-043376 A
[Patent Document 5] JP2021-067801 A

### SUMMARY OF THE INVENTION

For example, Patent Documents 1 to 3 disclose imaging optical systems that are compatible with large-sized imaging elements and are expected to perform auto focus. In Patent Documents 1 to 3, the weights of the focus lenses are reduced, and particularly, in Patent Documents 2 and 3, the effect of favorable aberration correction by floating focus can be confirmed. However, in the examples, the imaging optical systems are approximately F1.8, and in a case where the aperture ratio is further increased, the entire lens system becomes larger.

In addition, Patent Documents 4 and 5 disclose further imaging optical systems having large aperture ratios. In Patent Documents 4 and 5, it can be seen that it is difficult to achieve both aberration correction and weight reduction in focusing in a case where further increase in aperture ratio is performed.

The present invention has been made in view of such circumstances, and an object of the present invention is to provide an imaging optical system that achieves both a large aperture ratio and favorable aberration correction in consideration of weight reduction of a focus lens that is mainly driven in focusing, being compatible with a large-sized imaging element.

In order to achieve the above object, an imaging optical system according to an embodiment of the present invention consists of, in order from an object side, a first lens group Gr1, a second lens group Gr2 that has a positive refractive power, a third lens group Gr3, a fourth lens group Gr4 that has a positive refractive power, and a fifth lens group Gr5 that has a negative refractive power. During focusing from infinity to a short distance, the second lens group Gr2 and the fourth lens group Gr4 move toward the object side along the same path on an optical axis.

Further, an imaging optical system according to the embodiment of the present invention consists of, in order from the object side, a first lens group Gr1, a second lens group Gr2 that has a positive refractive power, a third lens group Gr3, a fourth lens group Gr4 that has a positive refractive power, and a fifth lens group Gr5 that has a negative refractive power. During focusing from infinity to a short distance, the second lens group Gr2 and the fourth lens group Gr4 move toward the object side along an optical axis, and the following conditional expression is satisfied.

$$0.20 < f 2 / f 1 < 1.5 \qquad ( 1 )$$

f2: focal length of the second lens group Gr2
f1: focal length of the first lens group Gr1

In addition, an imaging optical system according to the embodiment of the present invention consists of, in order from the object side, a first lens group Gr1, a second lens group Gr2 that has a positive refractive power, a third lens group Gr3, a fourth lens group Gr4 that has a positive refractive power, and a fifth lens group Gr5 that has a negative refractive power. During focusing from infinity to a short distance, the second lens group Gr2 and the fourth lens group Gr4 move toward the object side along the optical axis, a maximum ray height in the second lens group Gr2 is higher than a maximum ray height in the fourth lens group Gr4, and the following conditional expression is satisfied.

$$1. < YGr 2 / YGr 4 < 3. \qquad ( 2 )$$

YGr2: maximum ray height in the second lens group Gr2
YGr4: maximum ray height in the fourth lens group Gr4

Further, an imaging optical system according to the embodiment of the present invention consists of, in order from the object side, a first lens group Gr1, a second lens group Gr2 that has a positive refractive power, a third lens group Gr3, a fourth lens group Gr4 that has a positive refractive power, and a fifth lens group Gr5 that has a negative refractive power. During focusing from infinity to a short distance, the second lens group Gr2 and the fourth lens group Gr4 move toward the object side along an optical axis, a lens surface of the third lens group Gr3 closest to the object side is surface convex toward the object side, and the following conditional expression is satisfied.

$$1.10 < dGr 23 / dL min \qquad ( 3 )$$

dGr23: length on the optical axis from surface of the second lens group Gr2 closest to image side to surface of the third lens group Gr3 closest to object side during focusing on infinity
dLmin: length on the optical axis of lens having shortest length on optical axis (where, length of optical element formed of cement having effect of aberration correction of compound aspherical surface, diffraction element, or the like is excluded)

### Advantage of the Invention

According to the imaging optical system of the embodiment of the present invention, it is possible to achieve both a large aperture ratio and favorable aberration correction in consideration of weight reduction of the focus lens that is mainly driven in focusing, applying a large-sized imaging element.

### BRIEF DESCRIPTION OF THE DRAWINGS

FIG. 1 is a lens configuration diagram according to Example 1 in an imaging optical system of the present invention.

FIG. 2 is a longitudinal aberration diagram at an infinite photographing distance in the imaging optical system of Example 1.

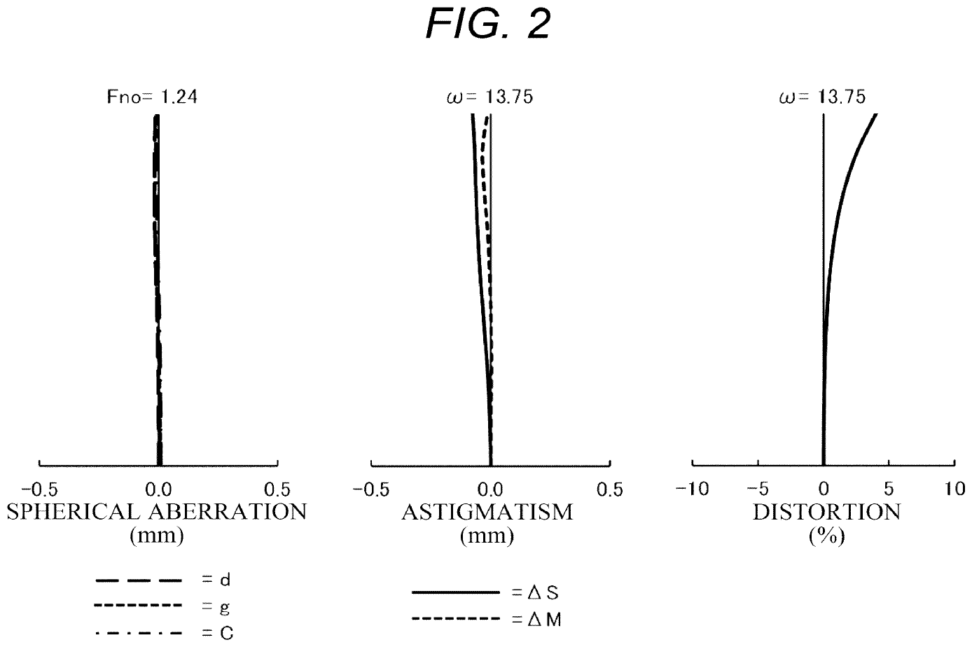

FIG. 3 is a longitudinal aberration diagram at a focusing distance of 1.812 m in the imaging optical system of Example 1.

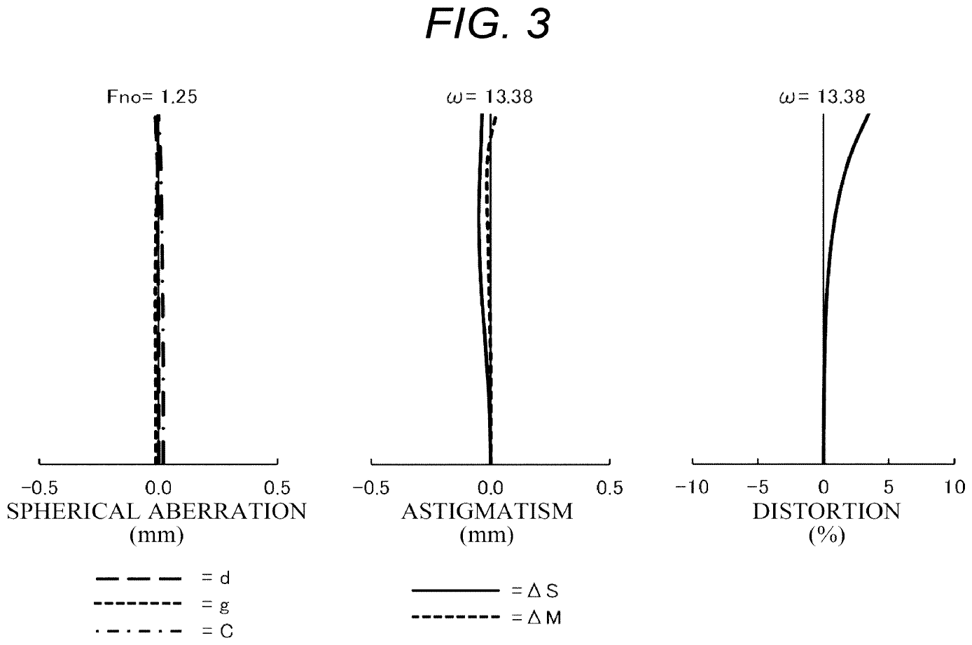

FIG. 4 is a longitudinal aberration diagram at a focusing distance of 0.858 m in the imaging optical system of Example 1.

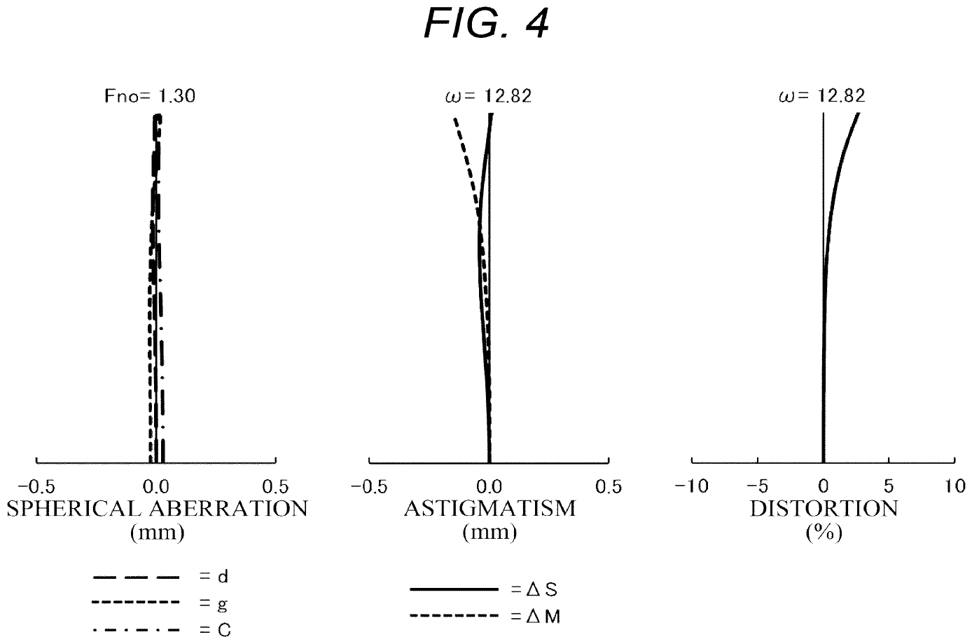

FIG. 5 is a lateral aberration diagram at an infinite photographing distance in the imaging optical system of Example 1.

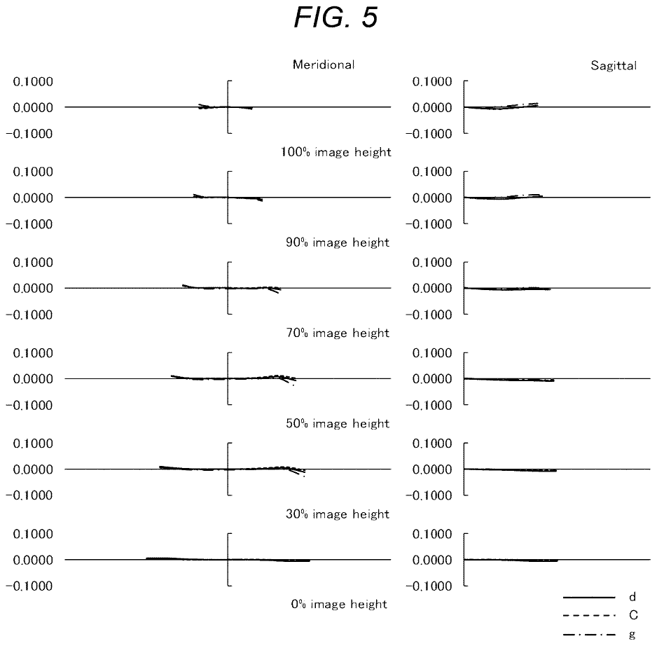

FIG. 6 is a lateral aberration diagram at a focusing distance of 1.812 m in the imaging optical system of Example 1.

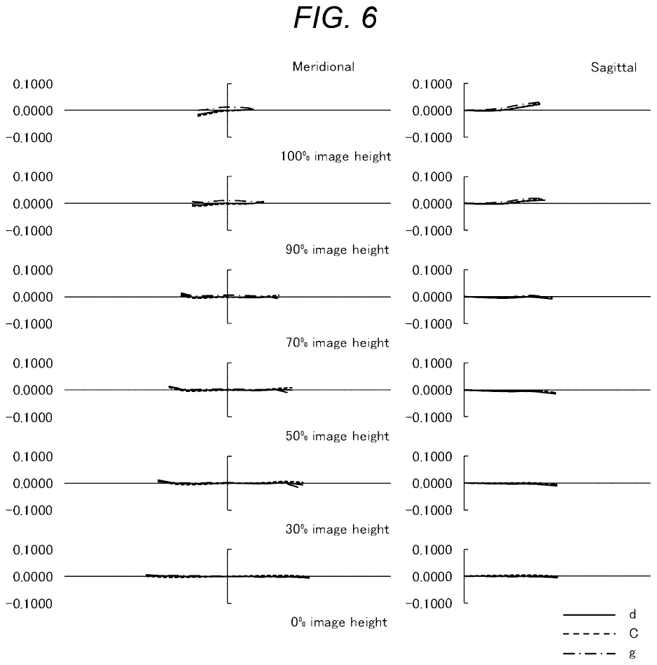

FIG. 7 is a lateral aberration diagram at a focusing distance of 0.858 m in the imaging optical system of Example 1.

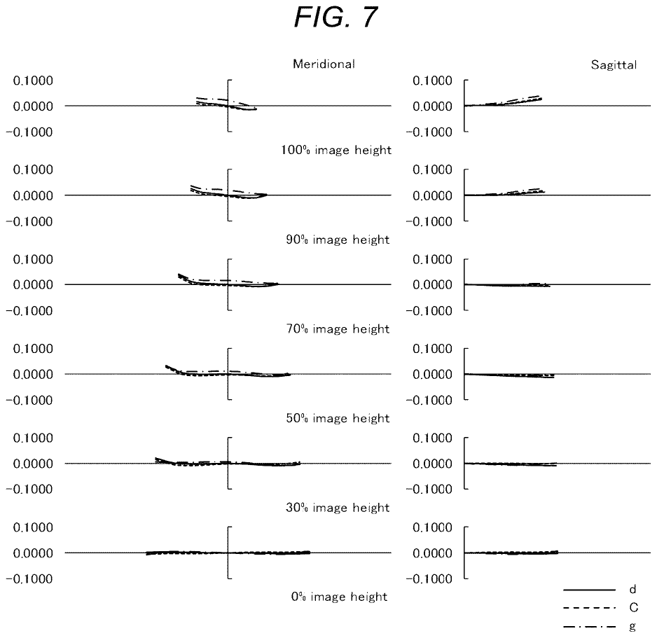

FIG. 8 is a lens configuration diagram according to Example 2 of the imaging optical system of the present invention.

FIG. 9 is a longitudinal aberration diagram at an infinite photographing distance in the imaging optical system of Example 2.

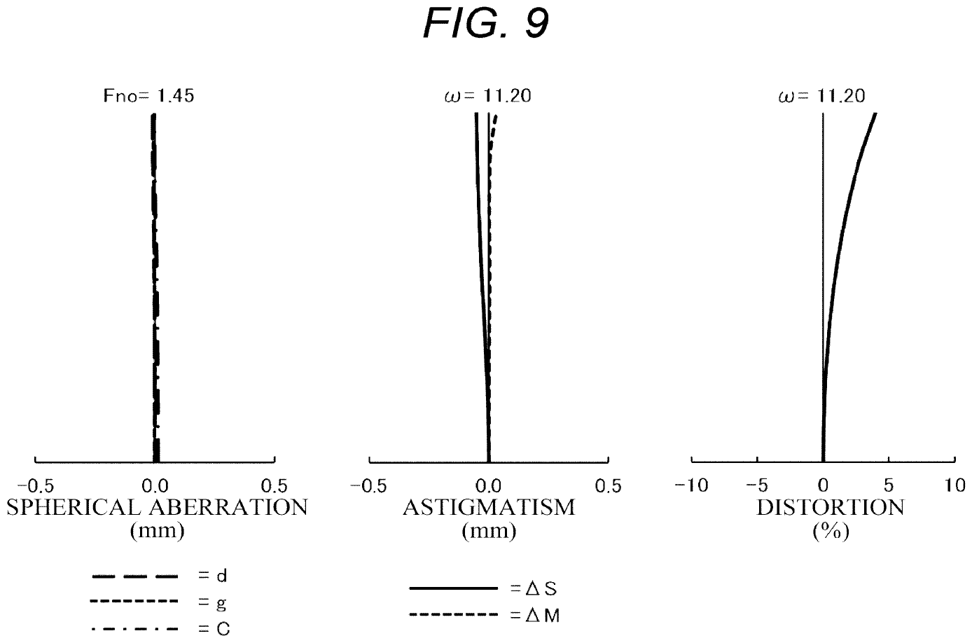

FIG. 10 is a longitudinal aberration diagram at a focusing distance of 2.214 m in the imaging optical system of Example 2.

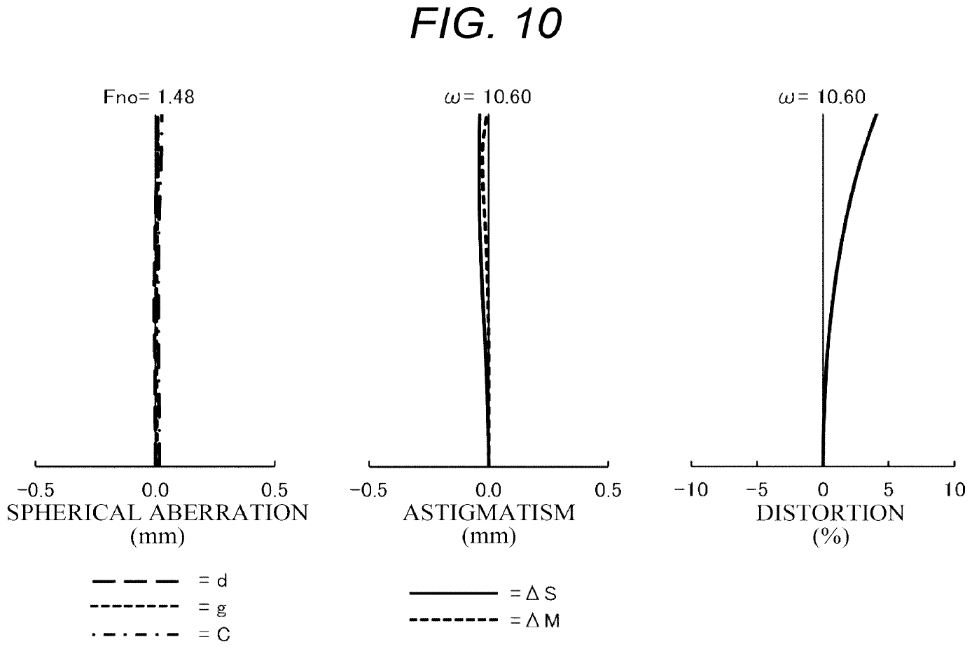

FIG. 11 is a longitudinal aberration diagram at a focusing distance of 1.042 m in the imaging optical system of Example 2.

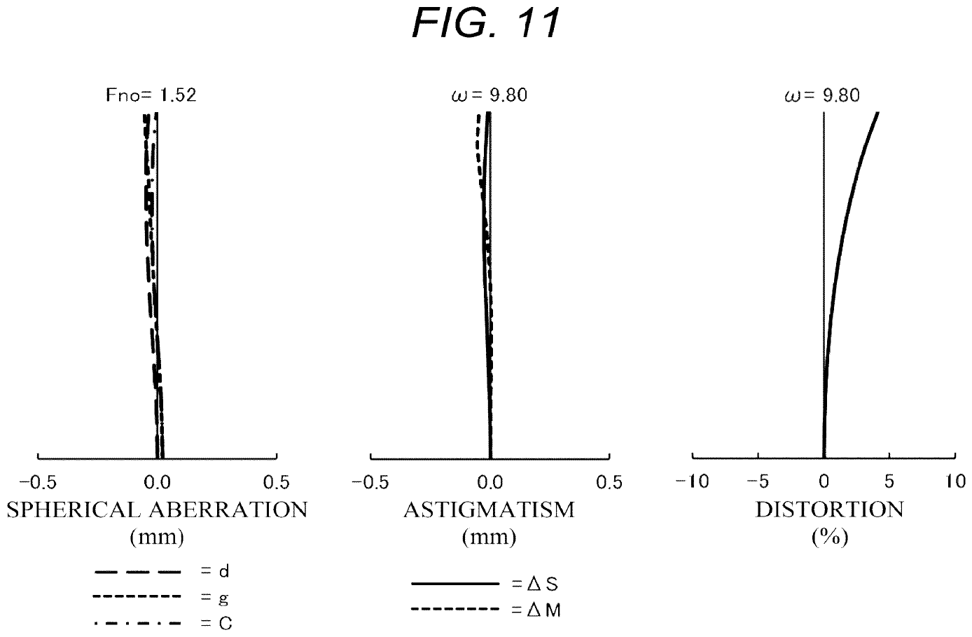

FIG. 12 is a lateral aberration diagram at an infinite photographing distance in the imaging optical system of Example 2.

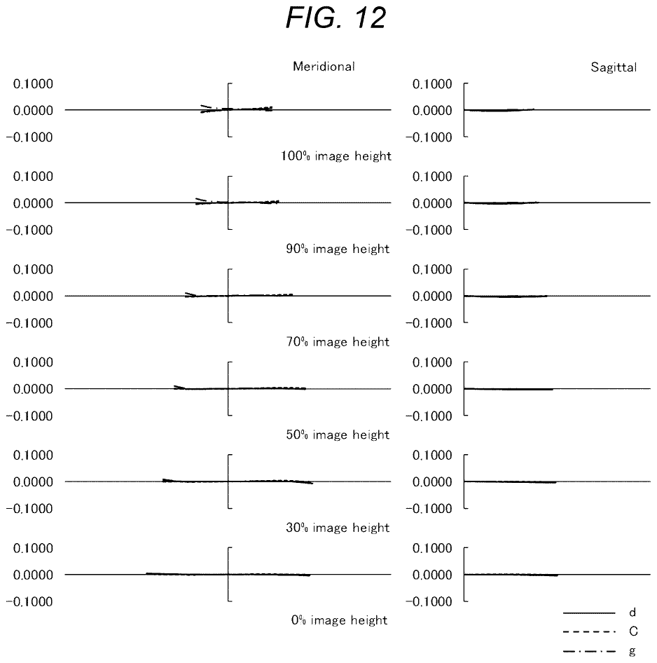

FIG. 13 is a lateral aberration diagram at a focusing distance of 2.214 m in the imaging optical system of Example 2.

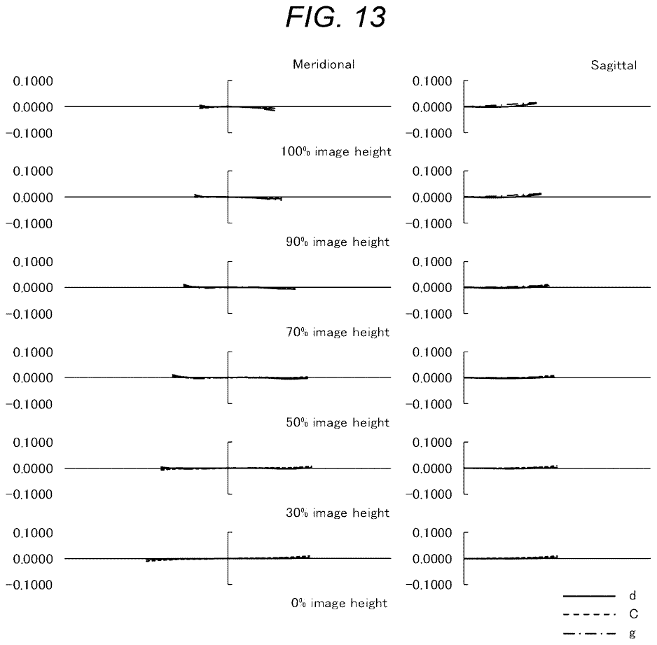

FIG. 14 is a lateral aberration diagram at a focusing distance of 1.042 m in the imaging optical system of Example 2.

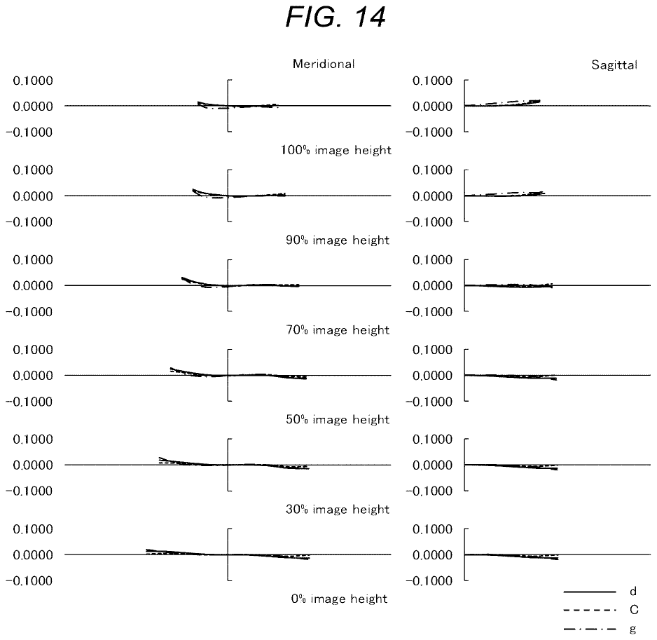

FIG. 15 is a lens configuration diagram according to Example 3 in the imaging optical system of the present invention.

FIG. 16 is a longitudinal aberration diagram at an infinite photographing distance in the imaging optical system of Example 3.

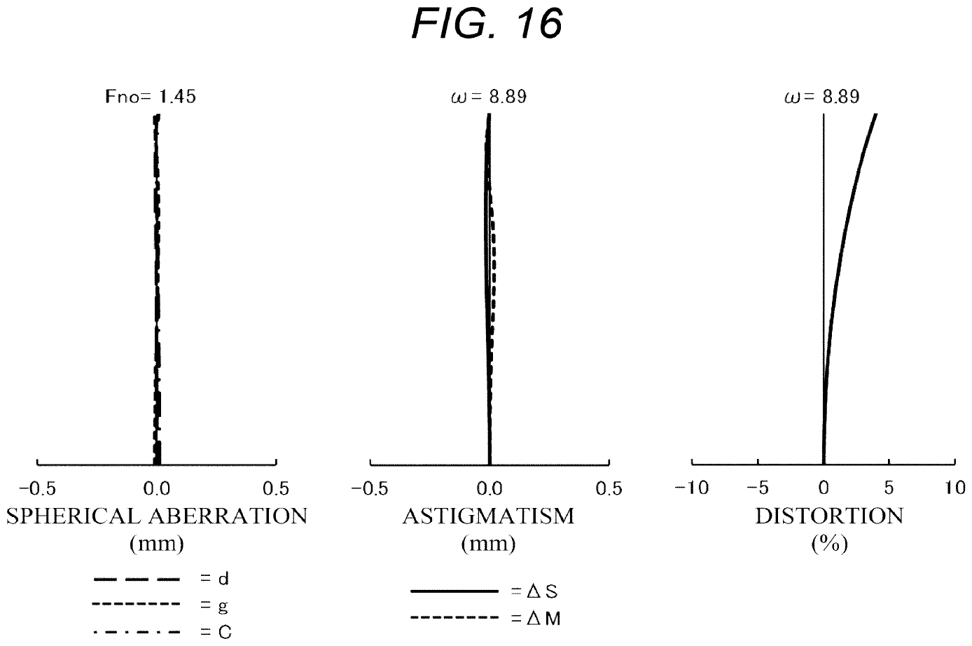

FIG. 17 is a longitudinal aberration diagram at a focusing distance of 2.771 m in the imaging optical system of Example 3.

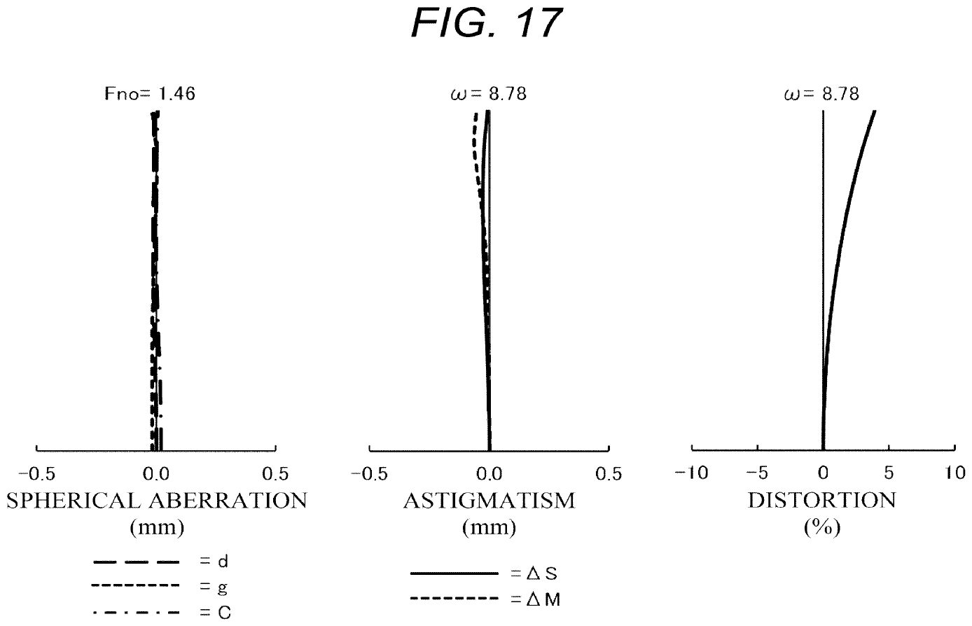

FIG. 18 is a longitudinal aberration diagram at a focusing distance of 1.282 m in the imaging optical system of Example 3.

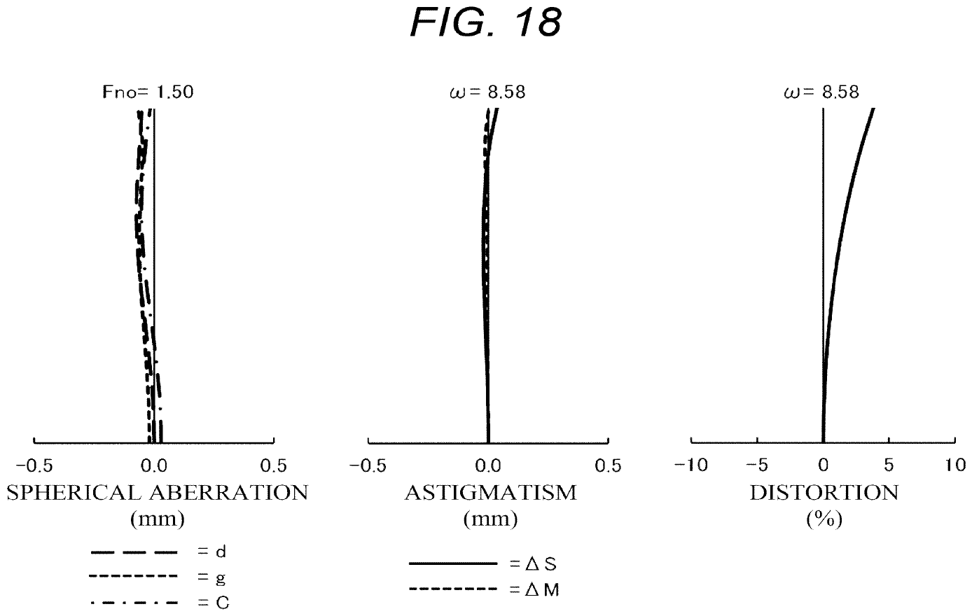

FIG. 19 is a lateral aberration diagram at an infinite photographing distance in the imaging optical system of Example 3.

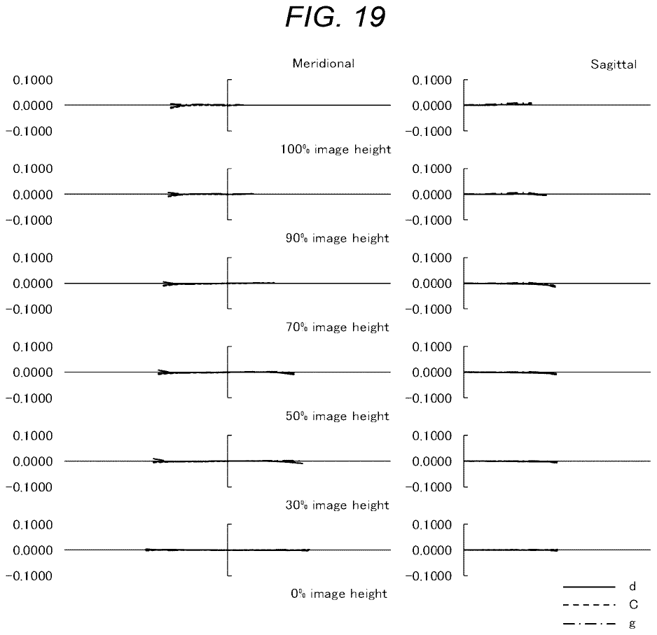

FIG. 20 is a lateral aberration diagram at a focusing distance of 2.771 m in the imaging optical system of Example 3.

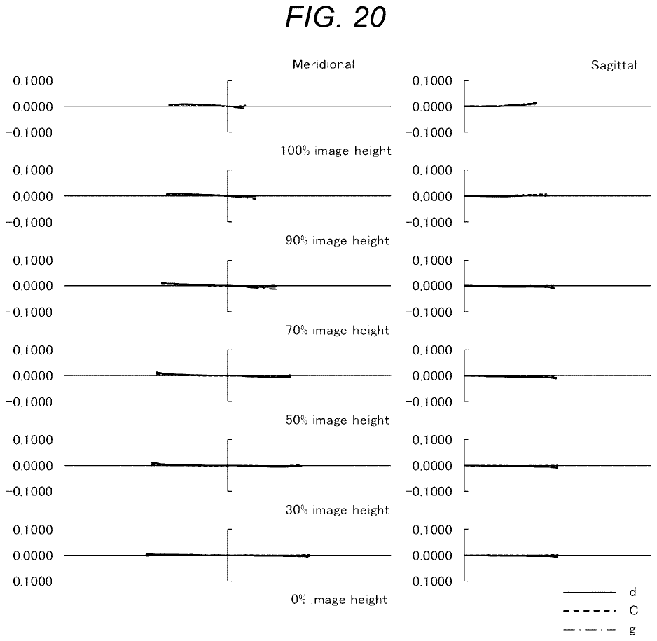

FIG. 21 is a lateral aberration diagram at a focusing distance of 1.282 m in the imaging optical system of Example 3.

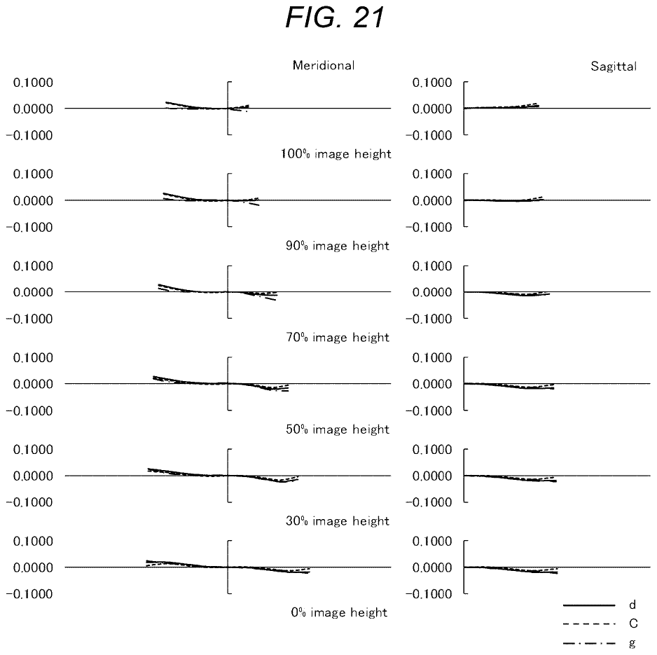

FIG. 22 is a lens configuration diagram according to Example 4 of the imaging optical system of the present invention.

FIG. 23 is a longitudinal aberration diagram at an infinite photographing distance in the imaging optical system of Example 4.

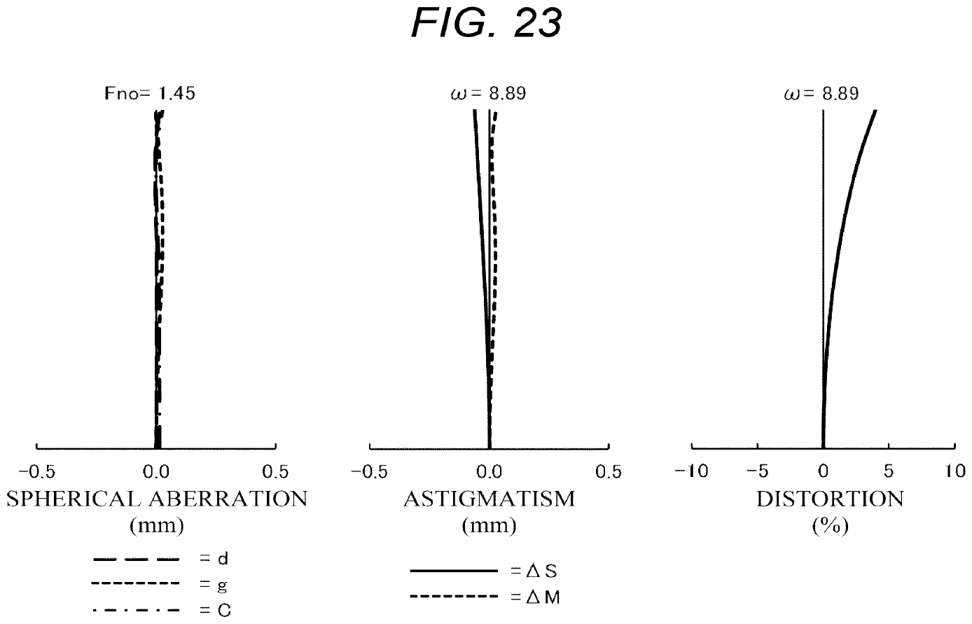

FIG. 24 is a longitudinal aberration diagram at a focusing distance of 2.769 m in the imaging optical system of Example 4.

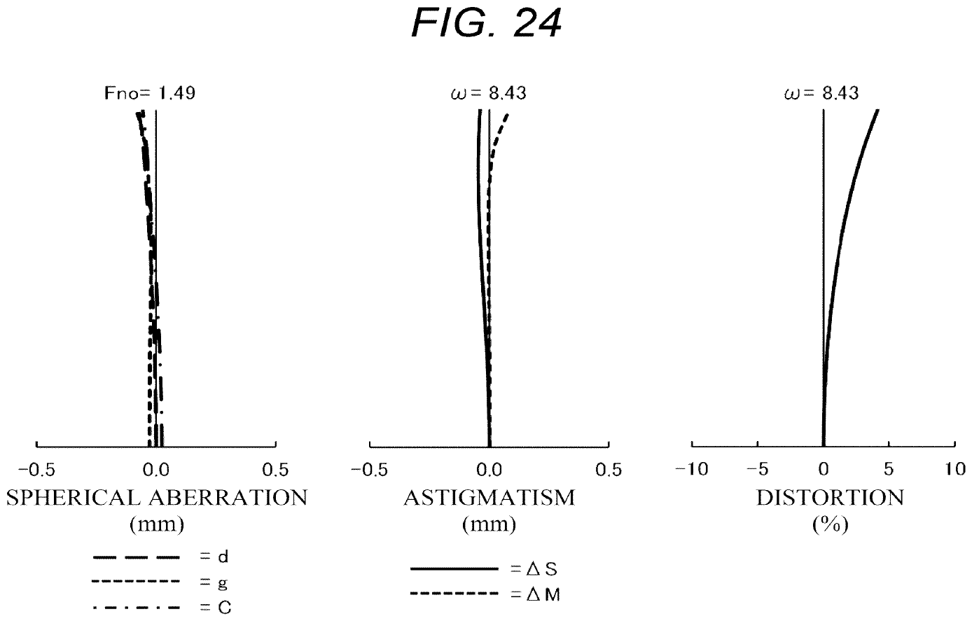

FIG. 25 is a longitudinal aberration diagram at a focusing distance of 1.269 m in the imaging optical system of Example 4.

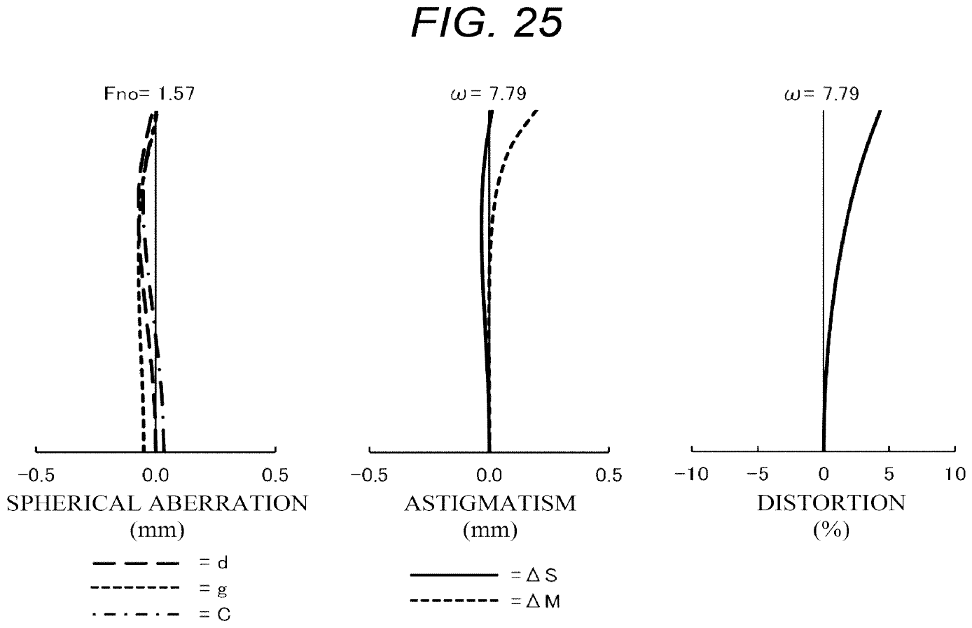

FIG. 26 is a lateral aberration diagram at an infinite photographing distance in the imaging optical system of Example 4.

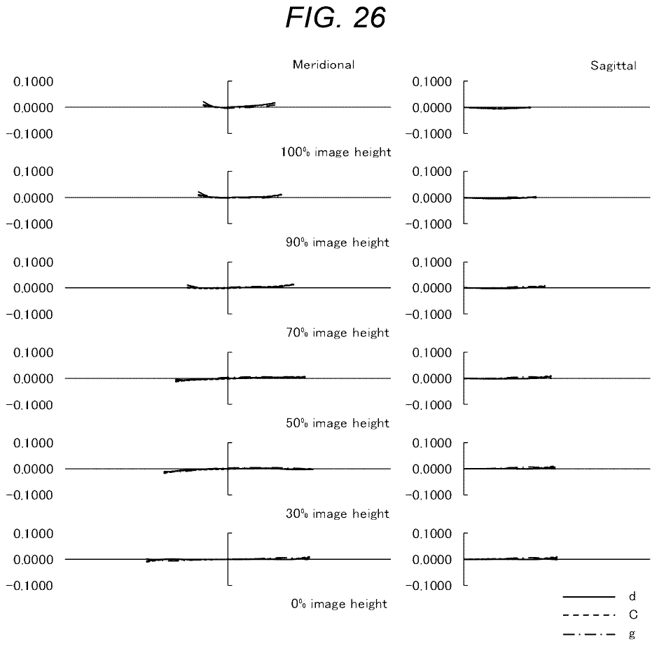

FIG. 27 is a lateral aberration diagram at a focusing distance of 2.769 m in the imaging optical system of Example 4.

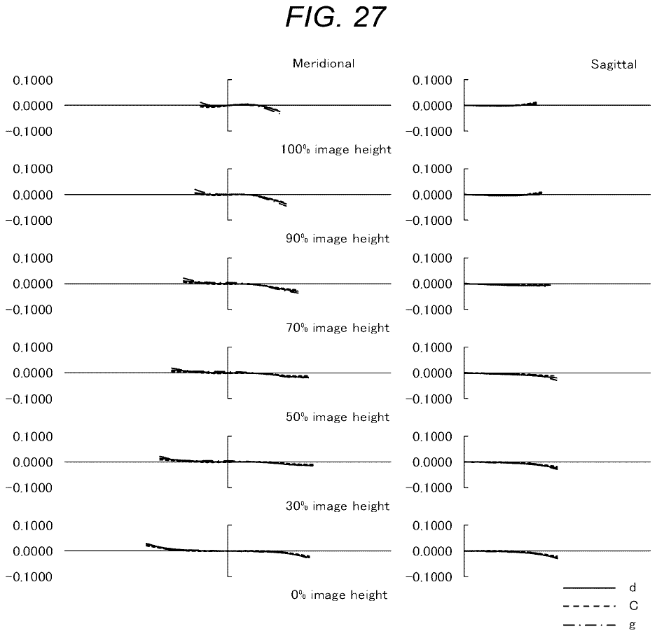

FIG. 28 is a lateral aberration diagram at a focusing distance of 1.269 m in the imaging optical system of Example 4.

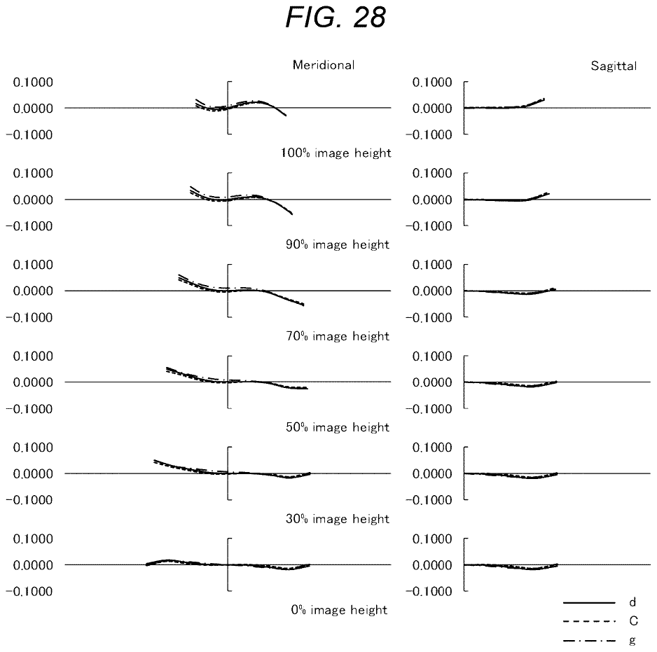

FIG. 29 is a lens configuration diagram according to Example 5 in the imaging optical system of the present invention.

FIG. 30 is a longitudinal aberration diagram at an infinite photographing distance in the imaging optical system of Example 5.

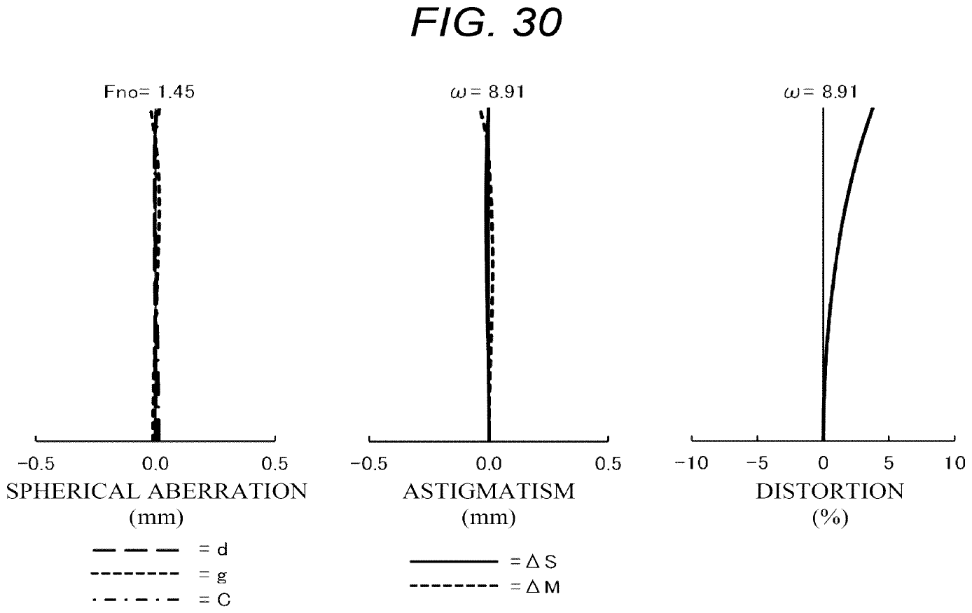

FIG. 31 is a longitudinal aberration diagram at a focusing distance of 2.764 m in the imaging optical system of Example 5.

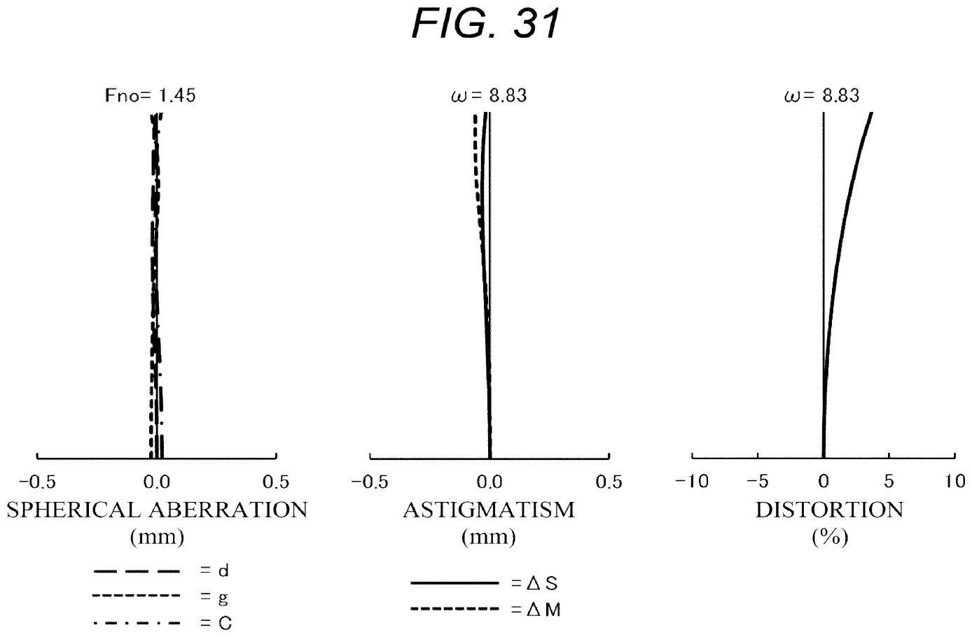

FIG. 32 is a longitudinal aberration diagram at a focusing distance of 1.275 m in the imaging optical system of Example 5.

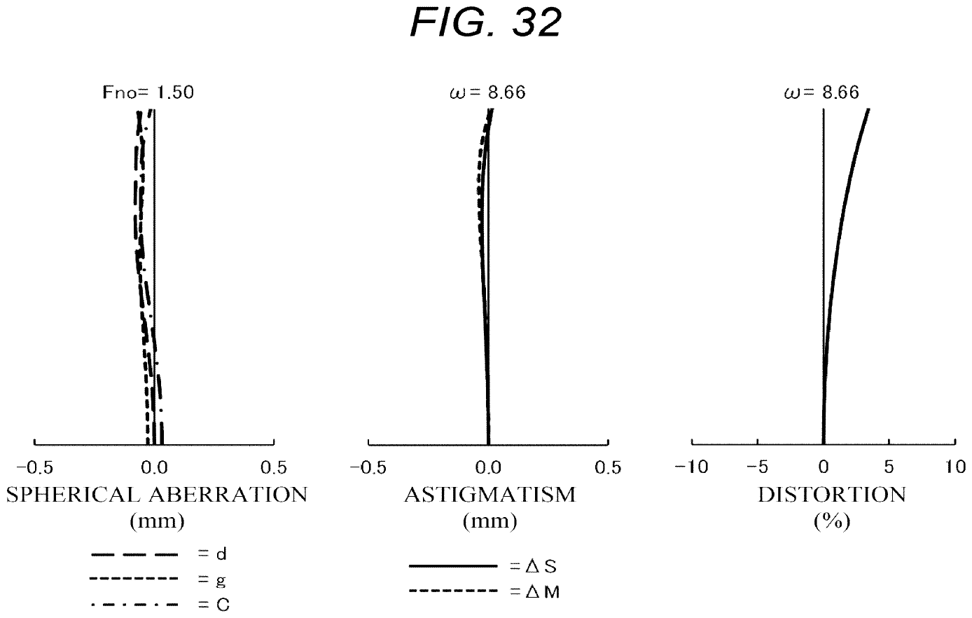

FIG. 33 is a lateral aberration diagram at an infinite photographing distance in the imaging optical system of Example 5.

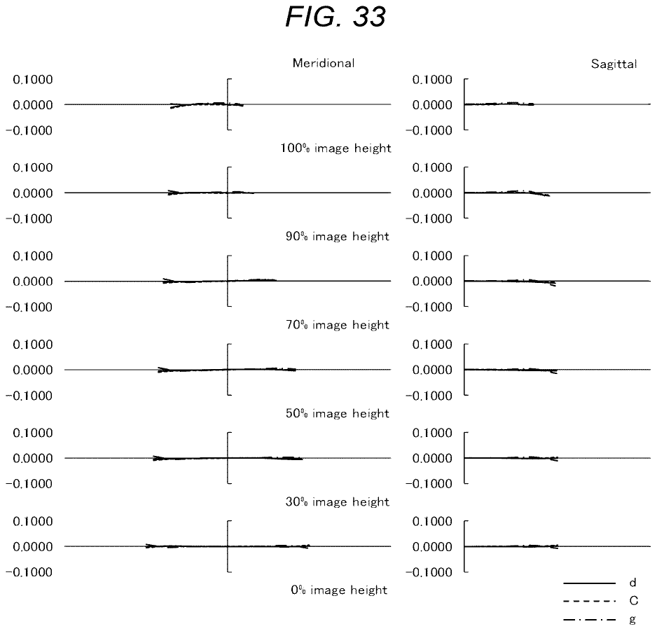

FIG. 34 is a lateral aberration diagram at a focusing distance of 2.764 m in the imaging optical system of Example 5.

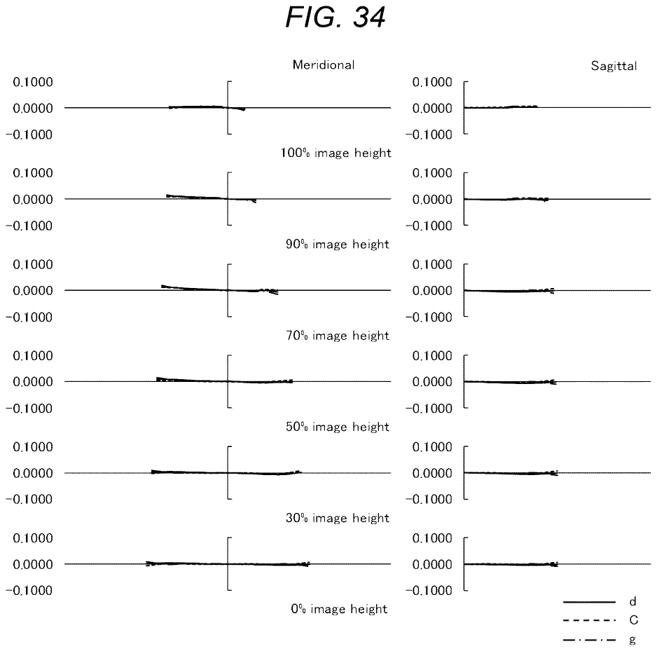

FIG. 35 is a lateral aberration diagram at a focusing distance of 1.275 m in the imaging optical system of Example 5.

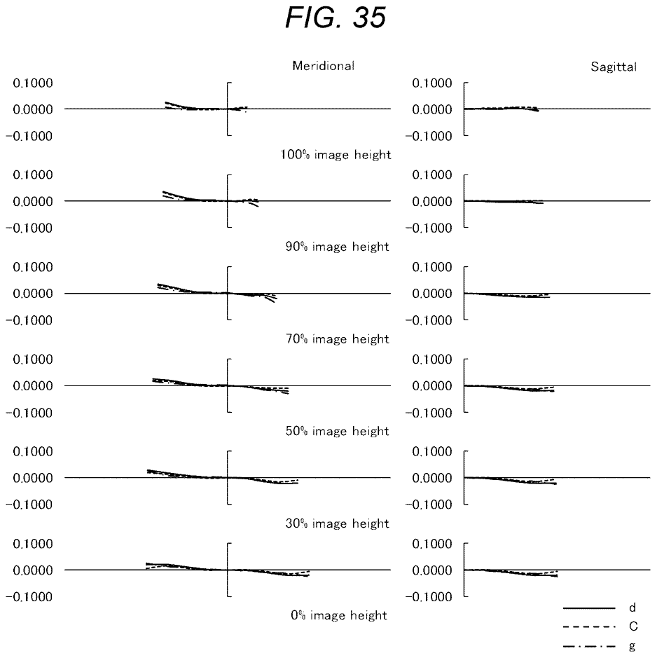

FIG. 36 is a lens configuration diagram according to Example 6 in the imaging optical system of the present invention.

FIG. 37 is a longitudinal aberration diagram at an infinite photographing distance in the imaging optical system of Example 6.

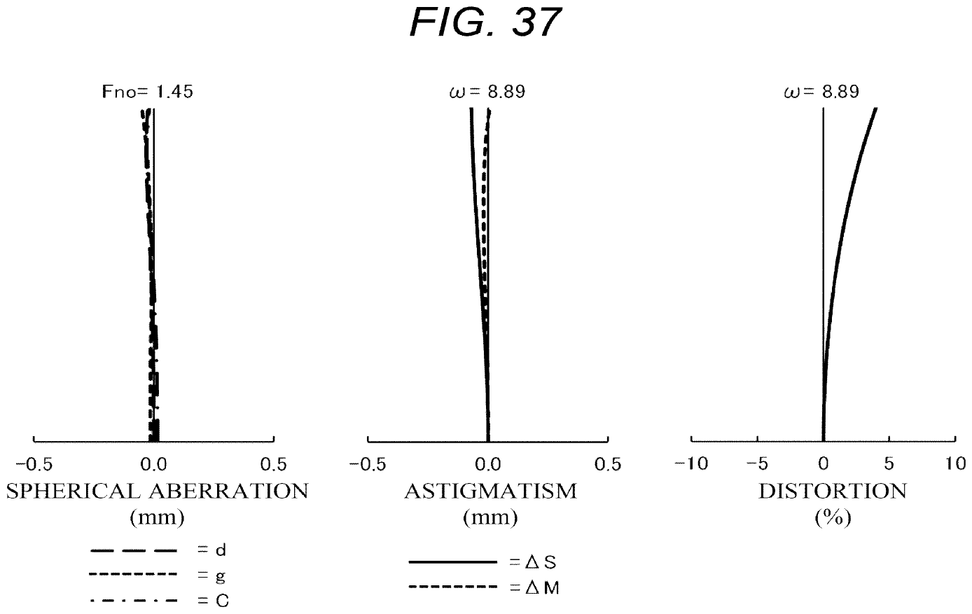

FIG. 38 is a longitudinal aberration diagram at a focusing distance of 2.773 m in the imaging optical system of Example 6.

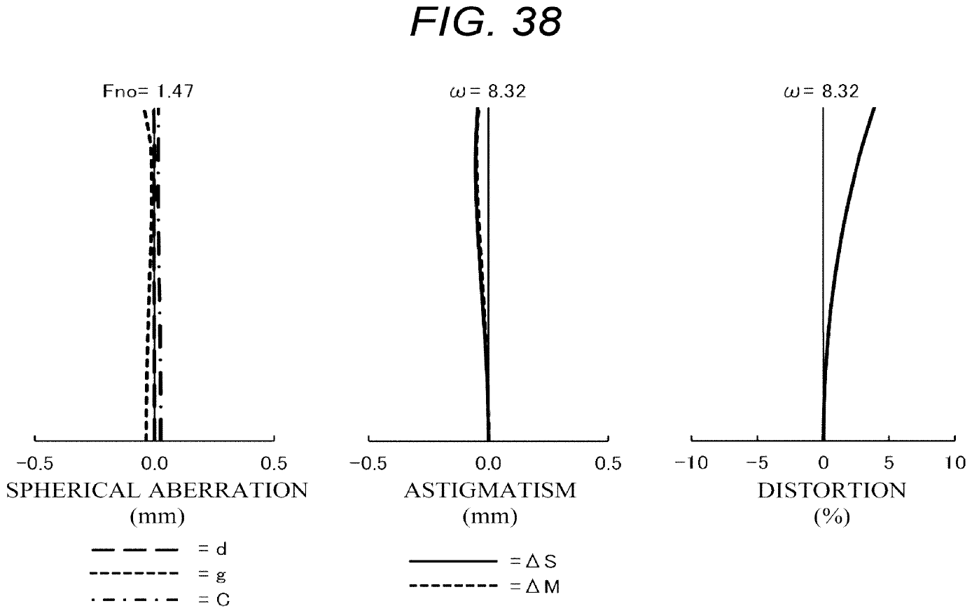

FIG. 39 is a longitudinal aberration diagram at a focusing distance of 1.285 m in the imaging optical system of Example 6.

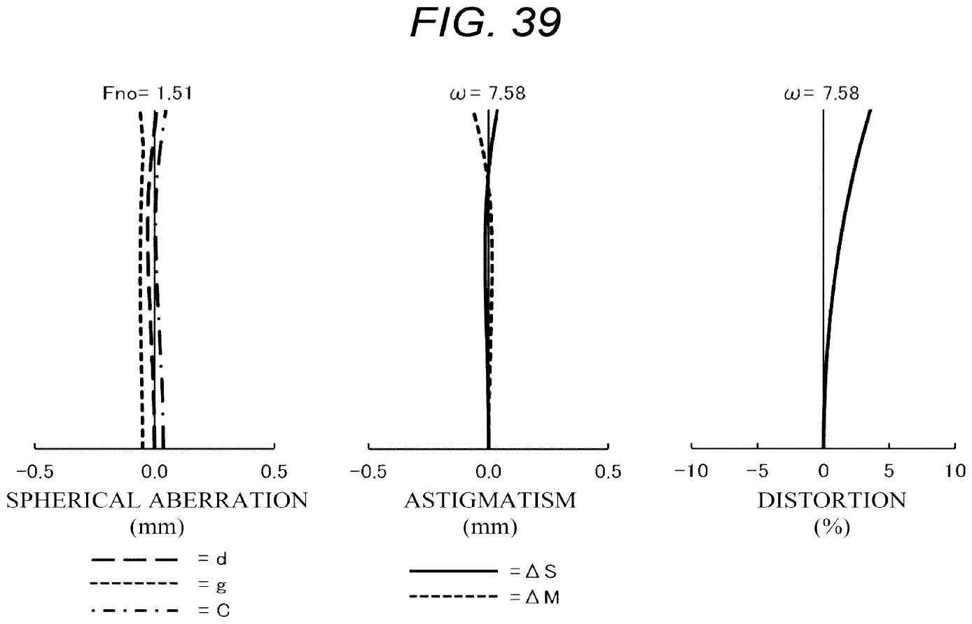

FIG. 40 is a lateral aberration diagram at an infinite photographing distance in the imaging optical system of Example 6.

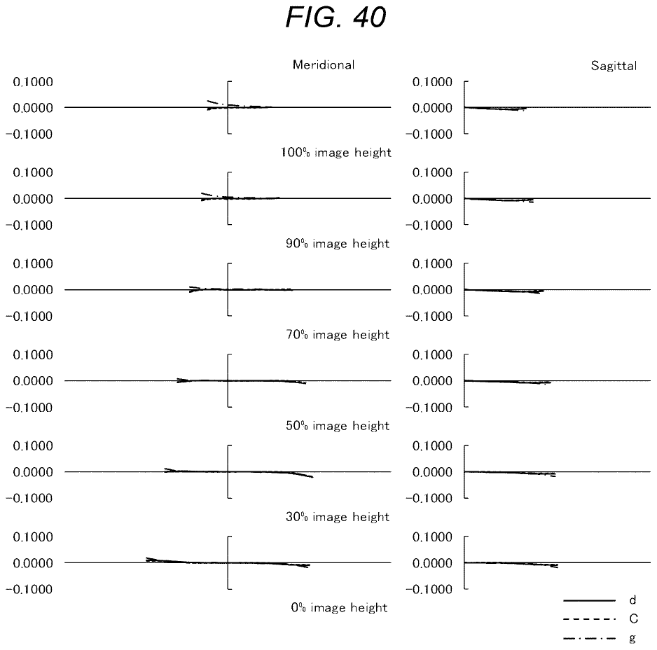

FIG. 41 is a lateral aberration diagram at a focusing distance of 2.773 m in the imaging optical system of Example 6.

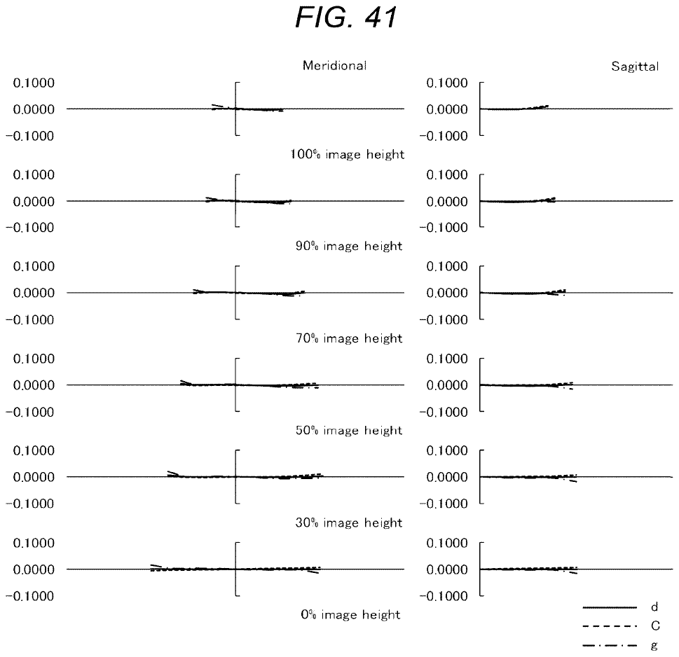

FIG. 42 is a lateral aberration diagram at a focusing distance of 1.285 m in the imaging optical system of Example 6.

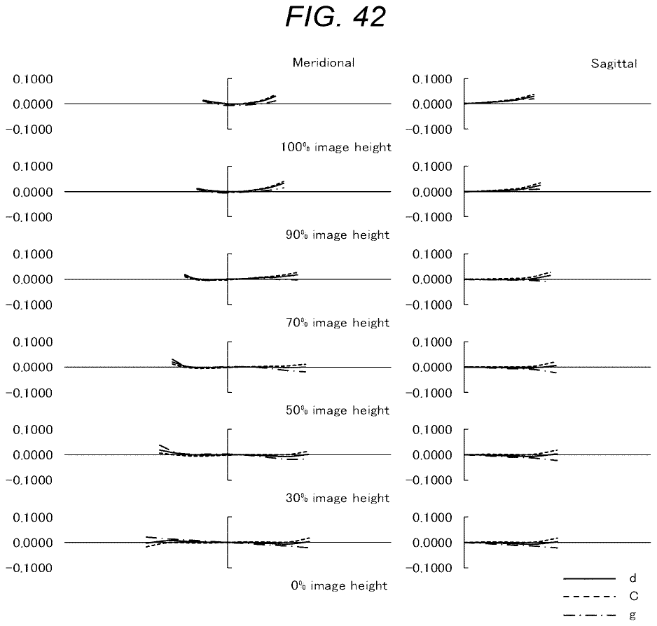

FIG. 43 is a lens configuration diagram according to Example 7 in the imaging optical system of the present invention.

FIG. 44 is a longitudinal aberration diagram at an infinite photographing distance in the imaging optical system of Example 7.

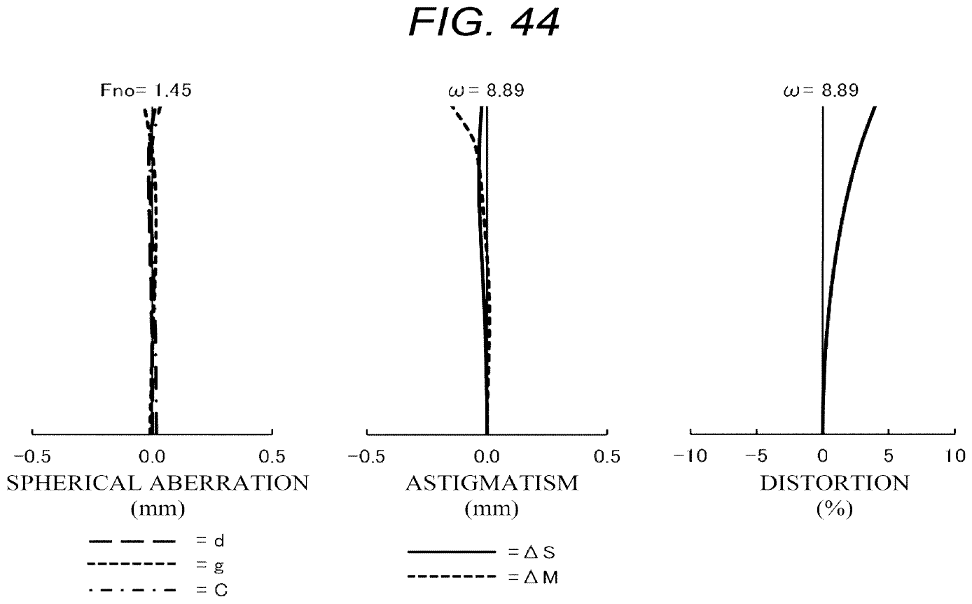

FIG. 45 is a longitudinal aberration diagram at a focusing distance of 2.726 m in the imaging optical system of Example 7.

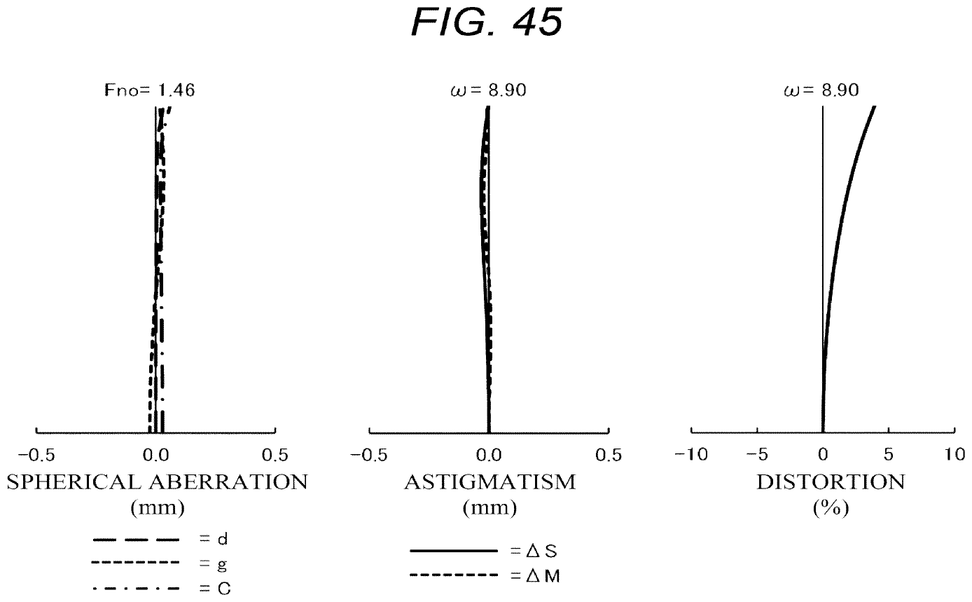

FIG. 46 is a longitudinal aberration diagram at a focusing distance of 1.248 m in the imaging optical system of Example 7.

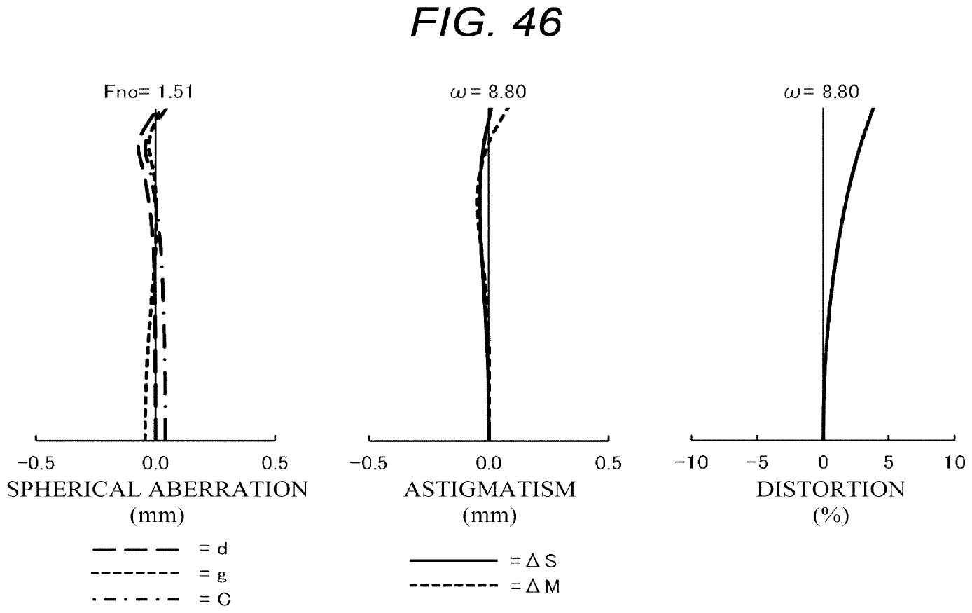

FIG. 47 is a lateral aberration diagram at an infinite photographing distance in the imaging optical system of Example 7.

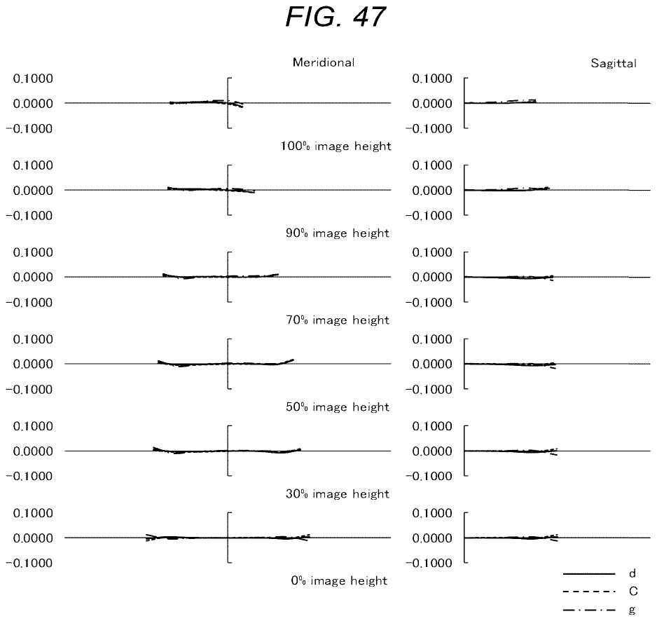

FIG. 48 is a lateral aberration diagram at a focusing distance of 2.726 m in the imaging optical system of Example 7.

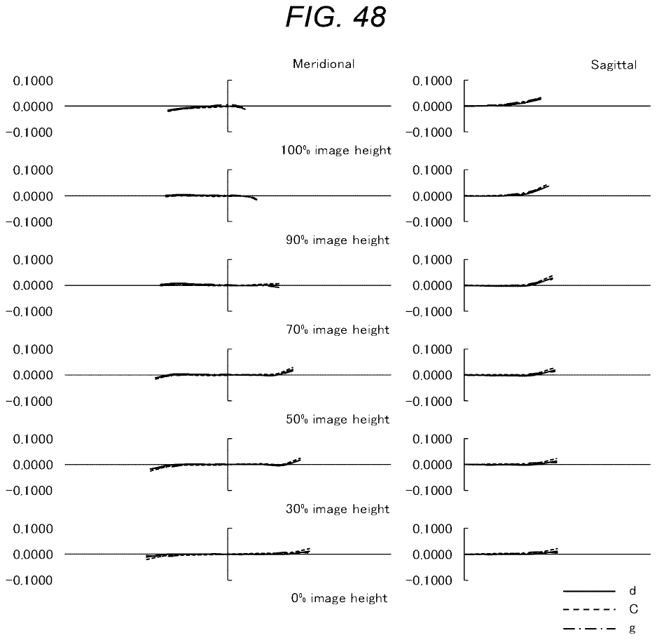

FIG. 49 is a lateral aberration diagram at a focusing distance of 1.248 m in the imaging optical system of Example 7.

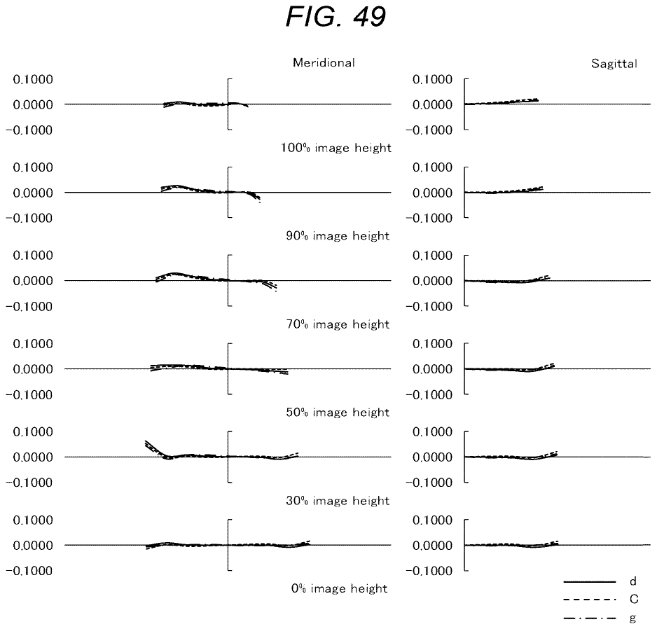

### EMBODIMENTS FOR CARRYING OUT THE INVENTION

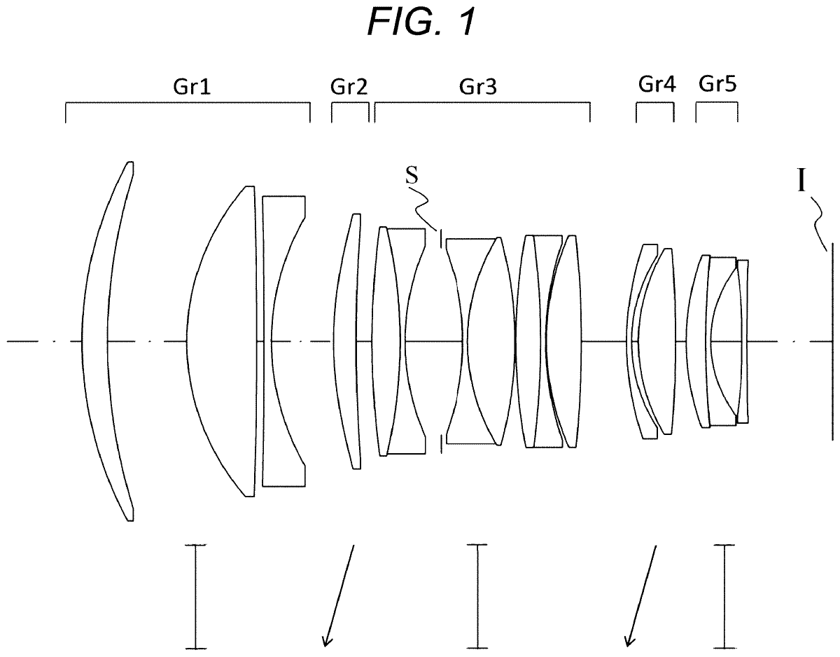

As shown in the lens configuration diagrams of FIGS. 1, 8, 15, 22, 29, 36, and 43, the imaging optical system of the present invention consists of, in order from the object side, a first lens group Gr1, a second lens group Gr2 that has a positive refractive power, a third lens group Gr3, a fourth lens group Gr4 that has a positive refractive power, and a fifth lens group Gr5 that has a negative refractive power, and is configured such that the second lens group Gr2 and the fourth lens group Gr4 move toward the object side along the optical axis during focusing from the infinity to the short distance. In the text, the lens component refers to a single lens or a cemented lens in which a plurality of lenses are cemented together.

The reason for adopting the above-described configuration will be described. It is necessary to appropriately dispose the lenses in order to satisfactorily perform aberration correction of the entire system. The focus lens group consists of, in order from the object side, a first lens group Gr1, a second lens group Gr2 that has a positive refractive power, a third lens group Gr3, a fourth lens group Gr4 that has a positive refractive power, and a fifth lens group Gr5 that has a negative refractive power. In a case where the second lens group Gr2 and the fourth lens group Gr4 are moved toward the object side along the optical axis during focusing from the infinity to the short distance, the focus lens group is easily reduced in weight and size, and the effect of the total length reduction due to the negative refractive power of the fifth lens group is also obtained. Therefore, it is possible to suppress an increase in size of the entire lens system.

The imaging optical system of the present invention consists of, in order from the object side, a first lens group Gr1, a second lens group Gr2 that has a positive refractive power, a third lens group Gr3, a fourth lens group Gr4 that has a positive refractive power, and a fifth lens group Gr5 that has a negative refractive power. The imaging optical system adopts a configuration in which the second lens group Gr2 and the fourth lens group Gr4 move toward the object side along the optical axis during focusing from the infinity to the short distance. By adopting this configuration, the lens group on the image side in the lens group that performs focusing can be made to have an effect of reducing the ray height, and both the weight reduction of the lens group that performs focusing and the favorable aberration correction can be achieved.

In the imaging optical system according to the embodiment of the present invention, during focusing from infinity to a short distance, the second lens group Gr2 and the fourth lens group Gr4 move toward the object side along the same path along the optical axis. In a case where the second lens group Gr2 and the fourth lens group Gr4 are driven by the same amount of instruction for software driving, the work of position adjustment can be simplified since the groups moving by focusing have the same path, and the position detection parts of the lens groups can be shared, which leads to cost reduction.

It is desirable that the imaging optical system according to the embodiment of the present invention satisfies the following conditional expression.

$$0.2 < f 2 / f 1 < 1.5 \qquad ( 1 )$$

f2: focal length of the second lens group Gr2
f1: focal length of the first lens group Gr1

Conditional Expression (1) specifies a ratio of the focal length of the second lens group Gr2 to the focal length of the first lens group Gr1 as a preferable condition for achieving reduction in size and aberration correction. In a case where the focal length of Gr2 exceeds the upper limit of Conditional Expression (1), it is difficult to reduce the lens diameter on the image side. In a case where the value of Conditional Expression (1) is below the lower limit and the focal length of Gr2 is decreased, the refractive power increases, and it is difficult to perform aberration correction such as spherical aberration.

It is noted that with regard to Conditional Expression (1) described above, it is desirable that the lower limit value thereof is 0.25, and in a case where the lower limit value thereof is further set to 0.30, the above-described effect can be made more reliable. In addition, it is desirable that the upper limit value is 1.10, and in a case where the upper limit value is further set to 1.00, the above-described effect can be made more reliable.

In the imaging optical system according to the embodiment of the present invention, it is desirable that a maximum ray height in the second lens group Gr2 is higher than a maximum ray height in the fourth lens group Gr4, and the following conditional expression is satisfied.

$$1. < YGr 2 / YGr 4 < 3. \qquad ( 2 )$$

YGr2: maximum ray height in the second lens group Gr2
YGr4: maximum ray height in the fourth lens group Gr4

Conditional Expression (2) is for specifying a ratio between the maximum ray height in the second lens group Gr2 and the maximum ray height in the fourth lens group Gr4 as a preferable condition for size reduction and aberration correction. In a case where the ray height of Gr2 exceeds the upper limit of Conditional Expression (2), it is difficult to reduce the weight of the second lens group. In addition, in order to reduce the ray in Gr4, the refractive power in Gr2 increases, and it is difficult to perform aberration correction such as spherical aberration. In a case where the ray height of Gr4 is high and the value of Conditional Expression (2) is below the lower limit, the diameter of the actuator for focusing around Gr4 increases, which is not preferable for reducing the weight or size of the product.

It is noted that with regard to Conditional Expression (2) described above, it is desirable that the lower limit value thereof is 1.05, and in a case where the lower limit value thereof is further set to 1.10, the above-described effect can be made more reliable. In addition, it is desirable that the upper limit value is 2.20, and in a case where the upper limit value is further set to 1.60, the above-described effect can be made more reliable.

In the imaging optical system according to the embodiment of the present invention, it is desirable that a lens surface of the third lens group Gr3 closest to the object side is surface convex toward the object side, and the following conditional expression is satisfied.

$$1.1 < dGr 23 / dL min \qquad ( 3 )$$

dGr23: length on optical axis from surface of the second lens group Gr2 closest to image side to surface of the third lens group Gr3 closest to object side during focusing on infinity
dLmin: length on optical axis of lens having shortest length on optical axis (where, length of optical element formed of cement having effect of aberration correction of compound aspherical surface, diffraction element, or the like is excluded)

Since the lens surface of the third lens group Gr3 closest to the object side is a surface convex toward the object side, the amount of comatic aberration occurring between the third lens group Gr3 and the second lens group Gr2 can be suppressed, and it is easy to avoid interference of the lens barrel during focusing. In addition, Conditional Expression (3) is a condition for avoiding interference of the lens barrel during focusing and for reducing the weight, and specifies a ratio of a length on the optical axis from the surface of the second lens group Gr2 closest to the image side to the surface of the third lens group Gr3 closest to the object side during focusing on infinity to a length on the optical axis of the lens that has a shortest length on the optical axis. In a case where the value of dGr23 is small and the value of Conditional Expression (3) is below the lower limit, it is difficult to avoid interference of the lens barrel during focusing. In addition, in a case where dLmin increases, the lens becomes heavy, which is not preferable. The upper limit of Conditional Expression (3) is not provided because the value thereof can be increased by the disposition of the aperture diaphragm or the like. In a case where the upper limit is provided, the upper limit is set to 16.0. In a case where the size exceeds the upper limit, the lens becomes larger, which is not preferable.

It is noted that with regard to Conditional Expression (3) described above, it is desirable that the lower limit value thereof is 1.20, and in a case where the lower limit value thereof is further set to 1.50, the above-described effect can be made more reliable. In addition, it is desirable that the upper limit value is 12.0, and in a case where the upper limit value is further set to 8.00, the above-described effect can be made more reliable.

It is desirable that the imaging optical system according to the embodiment of the present invention satisfies the following conditional expression.

$$0.30 < LGr 2 / LGr 4 < 2.50 \qquad ( 4 )$$

LGr2: length of the second lens group Gr2 on optical axis
LGr4: length of the fourth lens group Gr4 on optical axis

It is desirable that the second lens group Gr2 and the fourth lens group Gr4 are configured with the minimum number of lenses for weight reduction, and it is desirable that the air gap in the group is small for size reduction. Therefore, it is not preferable that only the length of one lens group on the optical axis is increased. Conditional Expression (4) specifies a ratio of lengths of the second lens group Gr2 and the fourth lens group Gr4 on the optical axis in order to reduce weights of the second lens group Gr2 and the fourth lens group Gr4. It is not preferable that the length of Gr2 on the optical axis is increased and the value of Conditional Expression (4) exceeds the upper limit or the length of Gr4 on the optical axis is increased and the value of Conditional Expression (4) is lower than the lower limit, because the length of the focus lens group on the optical axis increases in such cases, and the focus lens group becomes heavy.

It is noted that with regard to Conditional Expression (4) described above, it is desirable that the lower limit value thereof is 0.35, and in a case where the lower limit value thereof is further set to 0.40, the above-described effect can be made more reliable. In addition, it is desirable that the upper limit value is 2.10, and in a case where the upper limit value is further set to 1.60, the above-described effect can be made more reliable.

In the imaging optical system according to the embodiment of the present invention, it is desirable that the first lens group Gr1 has a lens component having a positive refractive power and a surface convex toward the object side at the position closest to the object side. In order to reduce the weight of the first lens group Gr1, it is important to lower the ray from the surface closest to the object side in the first lens group Gr1, and the above-mentioned effect can be reliably achieved by the lens component having the surface with a positive refractive power.

In the imaging optical system according to the embodiment of the present invention, it is desirable that an on-axis ray height at a lens surface closest to the object side in the first lens group Gr1 during focusing on infinity is higher than an on-axis ray height at a lens surface closest to the image side in the first lens group Gr1 during focusing on infinity, and the following conditional expression is satisfied.

$$1. < YGr 1 F / YGr 1 R < 4. \qquad ( 5 )$$

YGr1F: on-axis ray height at lens surface closest to object side in the first lens group Gr1 during focusing on infinity
YGr1R: on-axis ray height at lens surface closest to image side in the first lens group Gr1 during focusing on infinity

The first lens group Gr1 has the highest ray height in the entire lens system, and appropriately reducing the on-axis ray height contributes to reduction in size of the entire lens system. In addition, it is desirable to reduce the ray height in the first lens group Gr1 in order to reduce the weight of the second lens group Gr2 and the fourth lens group Gr4 that perform focusing. In addition, Conditional Expression (5) specifies a ratio of an on-axis ray height at a lens surface closest to the object side in the first lens group Gr1 during focusing on infinity to an on-axis ray height at a lens surface closest to the image side in the first lens group Gr1 during focusing on infinity, as a preferable condition of Conditional Expression (5). In a case where the ray height of the lens surface closest to the image side in the first lens group Gr1 is excessively low and the value of Conditional Expression (5) exceeds the upper limit, various aberrations including spherical aberration generated in the first lens group Gr1 increase, and it is difficult to perform favorable aberration correction. In a case where the ray height of the lens surface closest to the image side in the first lens group Gr1 is lowered and the value of Conditional Expression (5) is lower than the lower limit, it is difficult to reduce the diameter of the lens disposed closer to the image side than the first lens group Gr1.

It is noted that with regard to Conditional Expression (5) described above, it is desirable that the lower limit value thereof is 1.10, and in a case where the lower limit value thereof is further set to 1.20, the above-described effect can be made more reliable. In addition, it is desirable that the upper limit value is 3.00, and in a case where the upper limit value is further set to 2.50, the above-described effect can be made more reliable.

In the imaging optical system according to the embodiment of the present invention, it is desirable that the first lens group Gr1 includes one or more lenses having a negative refractive power. In order to reduce the weight of the second lens group Gr2 that performs focusing, it is important to perform aberration correction in the first lens group Gr1. In a case where there is no lens having a negative refractive power, the number of lenses in the second lens group Gr2 is increased for the purpose of correcting aberration, and it is difficult to reduce the weight.

In the imaging optical system according to the embodiment of the present invention, it is desirable that the second lens group Gr2 consists of two or fewer lenses. It is desirable that the second lens group Gr2 that performs focusing is light, and it is desirable that the number of lenses is small for that purpose.

In the imaging optical system according to the embodiment of the present invention, it is desirable that the second lens group Gr2 consists of one lens. It is desirable that the second lens group Gr2 that performs focusing is light, and it is desirable that the number of lenses is one for this purpose.

In the imaging optical system according to the embodiment of the present invention, it is desirable that the second lens group Gr2 consists of one aspherical lens. It is desirable that the second lens group Gr2 that performs focusing is light, and it is desirable that the number of lenses is one for this purpose. In addition, it is desirable that the lens has an aspherical surface for favorable aberration correction during focusing.

In the imaging optical system according to the embodiment of the present invention, it is desirable that the second lens group Gr2 has an aspherical lens having a shape in which a convex power is reduced from the center of the optical axis toward the periphery. By having such an aspherical surface, it is possible to suppress occurrence of spherical aberration during focusing.

In the imaging optical system according to the embodiment of the present invention, it is desirable that the fourth lens group Gr4 consists of two or fewer lenses. It is desirable that the fourth lens group Gr4 that performs focusing is light, and it is desirable that the number of lenses is two or fewer for that purpose. In addition, it is more desirable that the number of sheets is one in order to further reduce the weight.

In the imaging optical system according to the embodiment of the present invention, it is desirable that the third lens group Gr3 includes one or more lenses having a positive refractive power. In order to reduce the size of the lens group closer to the image side than the third lens group Gr3, it is desirable that the third lens group Gr3 has a weak positive refractive power or a negative refractive power. Therefore, a lens having a positive refractive power is required as a lens configuration for the above.

Furthermore, it is desirable that the lens having a positive refractive power in the third lens group Gr3 satisfies the following conditional expression.

$$1. 60 < G 3 nd \qquad ( 11 )$$

G3nd: largest refractive index of d line among positive lenses in the third lens group Gr3

A material having a low refractive index is not preferable for the third lens group Gr3 in order to satisfactorily correct spherical aberration. In a case where the refractive index is lower than the lower limit of Conditional Expression (11), it is difficult to satisfactorily correct spherical aberration. Alternatively, in a case where favorable correction is to be maintained under this condition, the number of lenses is increased, and it is difficult to reduce the weight.

It is desirable that the imaging optical system according to the embodiment of the present invention satisfies the following conditional expression.

$$0.80 < β3 < 2. \qquad ( 6 )$$

ß3: lateral magnification of the third lens group Gr3 during focusing on infinity

In order to reduce the size of the lens group closer to the image side than the third lens group Gr3, it is desirable that the third lens group Gr3 has a weak positive refractive power or a negative refractive power. Conditional Expression (6) specifies a range of lateral magnification of the third lens group Gr3 during focusing on infinity, as a preferable condition. In a case where the lateral magnification exceeds the upper limit of Conditional Expression (6) and the lateral magnification increases, an effect of reducing the amount of focus movement of the second lens Gr2 is obtained. However, the amount of aberration correction in a case of focusing including the fourth lens group Gr4 is difficult because the amount of aberration correction in the second lens Gr2 increases. In a case where the lateral magnification is decreased below the lower limit of Conditional Expression (6), the effect of the convergence of the rays is increased, and it is difficult to impart a refractive power for focusing to the fourth lens group Gr4.

It is noted that with regard to Conditional Expression (6) described above, it is desirable that the lower limit value thereof is 0.90, and in a case where the lower limit value thereof is further set to 1.00, the above-described effect can be made more reliable. In addition, it is desirable that the upper limit value is 1.80, and in a case where the upper limit value is further set to 1.65, the above-described effect can be made more reliable.

It is desirable that the imaging optical system according to the embodiment of the present invention satisfies the following conditional expression.

$$0.80 < K 2 + K 4 < 4.00 \qquad ( 7 )$$

K2: focus sensitivity of the second lens group Gr2 during focusing on infinity
K4: focus sensitivity of the fourth lens group Gr4 during focusing on infinity

Here, the focus sensitivity K2 is set to K2=(1·ß\hat{ }2)*(ß345\hat{ }2), where ß2 is a lateral magnification of the second lens group Gr2 during focusing on infinity, and ß345 is a combined lateral magnification of the third lens group Gr3 and subsequent groups during focusing on infinity.

Here, it is assumed that the focus sensitivity K4 is K4=(1·ß4\hat{ }2)*(ß\hat{ }5), ß4 is a lateral magnification of the fourth lens group Gr4 during focusing on infinity, and ß5 is a lateral magnification of the fifth lens group Gr5 during focusing on infinity.

Conditional Expression (7) specifies a focus sensitivity synthesized by two moving lens groups for a stop accuracy of the focus and size reduction. In a case where the synthesized focus sensitivity exceeds the upper limit of Conditional Expression (7), it is difficult to satisfy the required stop accuracy of the focus lens group, and it is difficult to obtain favorable focusing performance in the auto focus. In a case where the synthesized focus sensitivity is lower than the lower limit of Conditional Expression (7), the movement amount of the lens during focusing increases, and it is difficult to reduce the size of the entire lens system.

It is noted that with regard to Conditional Expression (7) described above, it is desirable that the lower limit value thereof is 1.00, and in a case where the lower limit value thereof is further set to 1.10, the above-described effect can be made more reliable. In addition, it is desirable that the upper limit value is 2.90, and in a case where the upper limit value is further set to 2.35, the above-described effect can be made more reliable.

It is desirable that the imaging optical system according to the embodiment of the present invention satisfies the following conditional expression.

$$1. < β5 < 1.9 \qquad ( 8 )$$

$$0.3 < Δ xGr 2 / Δ xGr 4 < 2.5 \qquad ( 9 )$$

$$0.3 < β4 < 0.95 \qquad ( 10 )$$

ß5: lateral magnification of the fifth lens group Gr5 during focusing on infinity
ΔxGr2: movement amount of the second lens group Gr2 in focusing from infinity to short distance
ΔxGr4: movement amount of the fourth lens group Gr4 in focusing from infinity to short distance
ß4: lateral magnification of the fourth lens group Gr4 during focusing on infinity

Conditional Expression (8) specifies a range of the lateral magnification of the fifth lens group Gr5 having a negative refractive power during focusing on infinity for size reduction of the entire lens system and favorable aberration correction. In a case where the lateral magnification exceeds the upper limit of Conditional Expression (8) and the lateral magnification is large, the occurrence of positive distortion is large, which is not preferable. In addition, the effect of magnifying various aberrations including spherical aberration is increased, which is not preferable. In a case where the lateral magnification is decreased below the lower limit of Conditional Expression (8), the movement amount of the lens during focusing of the fourth lens group Gr4 increases, and it is difficult to reduce the size of the entire lens system. In addition, since the action of the telephoto type is weakened, it is difficult to shorten the total lens length.

It is noted that with regard to Conditional Expression (8) described above, it is desirable that the lower limit value thereof is 1.05, and in a case where the lower limit value thereof is further set to 1.10, the above-described effect can be made more reliable. In addition, it is desirable that the upper limit value is 1.70, and in a case where the upper limit value is further set to 1.60, the above-described effect can be made more reliable.

Conditional Expression (9) specifies a ratio of movement amounts of the second lens group Gr2 and the fourth lens group Gr4 during focusing with respect to the distribution of the aberrations of the focus lens group. By performing floating focus with these two lens groups, it is possible to cancel out spherical aberration, and it is possible to perform favorable aberration correction during focusing. It is not preferable that the movement amount of the fourth lens group is decreased in a case where the upper limit of Conditional Expression (9) is exceeded since the refractive power of the fourth lens group Gr4 is increased and various aberrations including spherical aberration are increased. In addition, in a case where the movement amount of the second lens group Gr2 having a high ray height and a heavy weight increases, the burden on the actuator for focusing increases, which is not preferable. It is not preferable that the value of Conditional Expression (9) is lower than the lower limit and the movement amount of the second lens group is decreased because the refractive power of the second lens group Gr2 is increased and various aberrations including spherical aberration are increased.

It is noted that for Conditional Expression (9) described above, it is desirable that the lower limit value thereof is 0.45, and in a case where the lower limit value thereof is further set to 0.47, the above-described effect can be made more reliable. In addition, it is desirable that the upper limit value is 1.80, and in a case where the upper limit value is further set to 1.65, the above-described effect can be made more reliable.

Conditional Expression (10) specifies a range of a lateral magnification of the fourth lens group Gr4 during focusing on infinity as a condition for preferable aberration correction. In a case where the upper limit of Conditional Expression (10) is exceeded and the lateral magnification of the fourth lens group is increased, the refractive power of the fourth lens group Gr4 is decreased, the ray height of the fourth lens group Gr4 is increased, and the diameter of the actuator for focusing around the fourth lens group Gr4 is increased. This is not preferable for reducing the weight or size of the product. It is not preferable that the value of Conditional Expression (10) is below the lower limit and the lateral magnification of the fourth lens group is decreased, since the refractive power of the fourth lens group Gr4 is increased and various aberrations including spherical aberration are increased.

It is noted that for Conditional Expression (10) described above, it is desirable that the lower limit value thereof is 0.40, and in a case where the lower limit value thereof is further set to 0.45, the above-described effect can be made more reliable. In addition, it is desirable that the upper limit value is 0.90, and in a case where the upper limit value is further set to 0.85, the above-described effects can be made more reliable.

Next, lens configurations of examples according to the imaging optical system of the present invention will be described. In the following description, the lens configuration will be described in order from the object side to the image side.

### Example 1

FIG. 1 is a lens configuration diagram of an imaging optical system of Example 1 of the present invention. The system consists of, in order from the object side, a first lens group Gr1 that has a positive refractive power, a second lens group Gr2 that has a positive refractive power, a third lens group Gr3 that has a positive refractive power, a fourth lens group Gr4 that has a positive refractive power, and a fifth lens group Gr5 that has a negative refractive power. During focusing from infinity to a short distance, the second lens group Gr2 and the fourth lens group Gr4 move toward the object side along the same path on the optical axis, and the first lens group Gr1, the third lens group Gr3, and the fifth lens group Gr5 remain stationary with respect to the image surface. The first lens group Gr1 consists of a positive meniscus lens convex toward the object side, a biconvex lens, and a biconcave lens. The second lens group Gr2 consists of a positive meniscus lens convex toward the object side, of which the object side surface is an aspherical surface. The third lens group Gr3 consists of a cemented lens of a biconvex lens and a biconcave lens, an aperture diaphragm, a cemented lens of a biconcave lens and a biconvex lens, a cemented lens of a biconvex lens and a biconcave lens, and a biconvex lens. The fourth lens group Gr4 consists of a negative meniscus lens convex toward the object side and a biconvex lens. The fifth lens group Gr5 consists of a cemented lens of a positive meniscus lens convex toward the object side and a negative meniscus lens convex toward the object side, and a biconcave lens of which both surfaces are aspherical. The second lens group Gr2 has an aspherical surface that weakens a convex power from the center of the optical axis to the periphery. A surface of the third lens group Gr3 closest to the object side is a surface convex toward the object side.

### Example 2

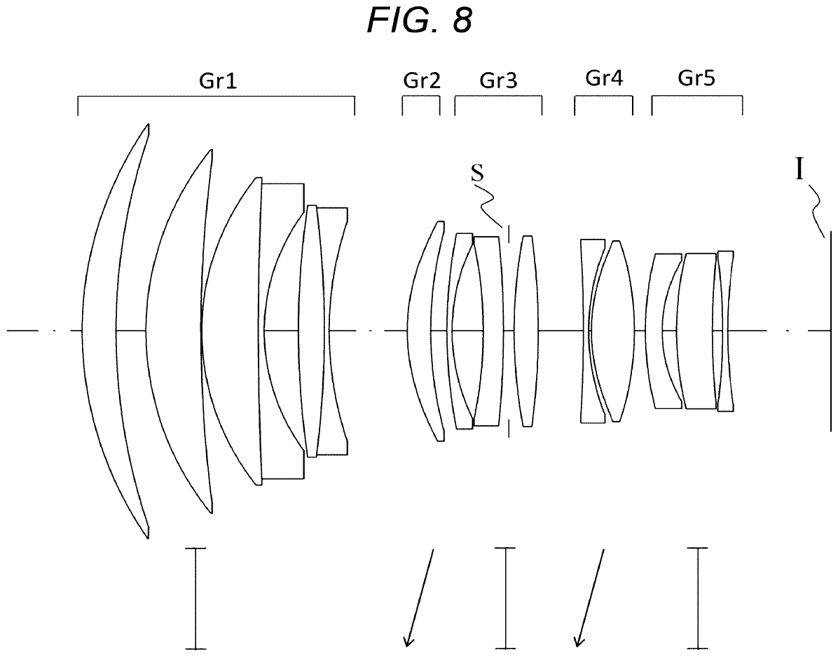

FIG. 8 is a lens configuration diagram of the imaging optical system of Example 2 of the present invention. The system consists of, in order from the object side, a first lens group Gr1 that has a positive refractive power, a second lens group Gr2 that has a positive refractive power, a third lens group Gr3 that has a positive refractive power, a fourth lens group Gr4 that has a positive refractive power, and a fifth lens group Gr5 that has a negative refractive power. During focusing from infinity to a short distance, the second lens group Gr2 and the fourth lens group Gr4 move toward the object side along the same path on the optical axis, and the first lens group Gr1, the third lens group Gr3, and the fifth lens group Gr5 remain stationary with respect to the image surface. The first lens group Gr1 consists of a positive meniscus lens convex toward the object side, a positive meniscus lens convex toward the object side, a cemented lens composed of a positive meniscus lens convex toward the object side and a negative meniscus lens convex toward the object side, and a cemented lens composed of a biconvex lens and a biconcave lens. The second lens group Gr2 consists of a positive meniscus lens convex toward the object side, of which the object side surface is an aspherical surface. The third lens group Gr3 consists of a negative meniscus lens convex toward the object side, a negative meniscus lens concave toward the object side, an aperture diaphragm, and a biconvex lens. The fourth lens group Gr4 consists of a biconcave lens and a biconvex lens of which both surfaces are aspherical. The fifth lens group Gr5 consists of a negative meniscus lens convex toward the object side, a positive meniscus lens convex toward the object side, and a biconcave lens. The second lens group Gr2 has an aspherical surface that weakens a convex power from the center of the optical axis to the periphery. A surface of the third lens group Gr3 closest to the object side is a surface convex toward the object side.

### Example 3

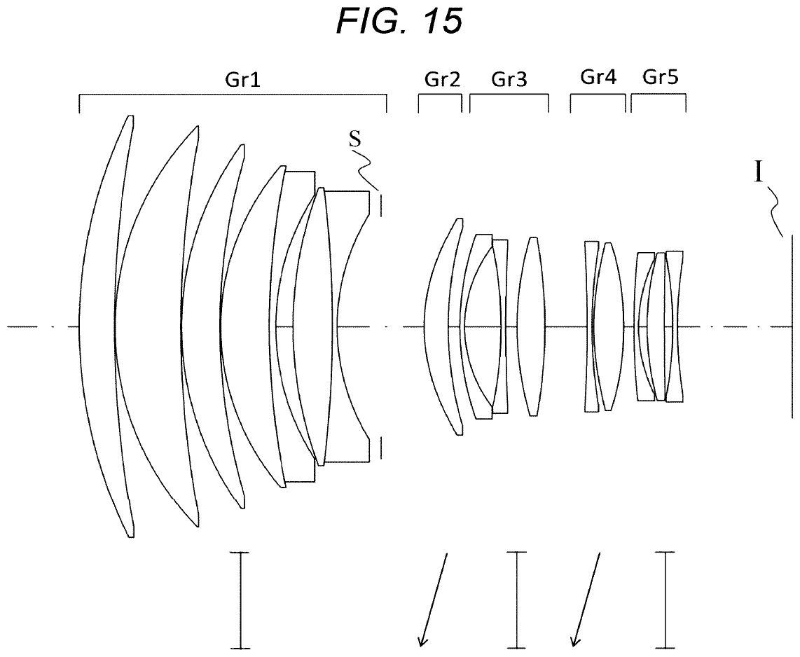

FIG. 15 is a lens configuration diagram of the imaging optical system of Example 3 of the present invention. The system consists of, in order from the object side, a first lens group Gr1 that has a positive refractive power, an aperture diaphragm, a second lens group Gr2 that has a positive refractive power, a third lens group Gr3 that has a negative refractive power, a fourth lens group Gr4 that has a positive refractive power, and a fifth lens group Gr5 that has a negative refractive power. During focusing from infinity to a short distance, the second lens group Gr2 and the fourth lens group Gr4 move toward the object side along the same path on the optical axis, the first lens group Gr1, the aperture diaphragm, the third lens group Gr3, and the fifth lens group Gr5 are fixed with respect to an image surface. The first lens group Gr1 consists of a positive meniscus lens that has a surface convex toward the object side, a positive meniscus lens that has a surface convex toward the object side, a positive meniscus lens that has a surface convex toward the object side, a cemented lens of a positive meniscus lens that has a surface convex toward the object side and a negative meniscus lens that has a surface convex toward the object side, and a cemented lens of a biconvex lens and a biconcave lens. The second lens group Gr2 consists of a positive meniscus lens that has a surface convex toward the object side and has an aspherical surface as a surface convex toward the object side. The third lens group Gr3 consists of a negative meniscus lens that has a surface convex toward the object side, a biconcave lens, and a biconvex lens. The fourth lens group Gr4 consists of a biconcave lens and a biconvex lens of which both surfaces are aspherical. The fifth lens group Gr5 consists of a negative meniscus lens that has a surface convex toward the object side, a positive meniscus lens that has a surface convex toward the object side, and a biconcave lens. The second lens group Gr2 has an aspherical surface that weakens a convex power from the center of the optical axis to the periphery, and a surface of the third lens group Gr3 closest to the object side is convex toward the object side.

### Example 4

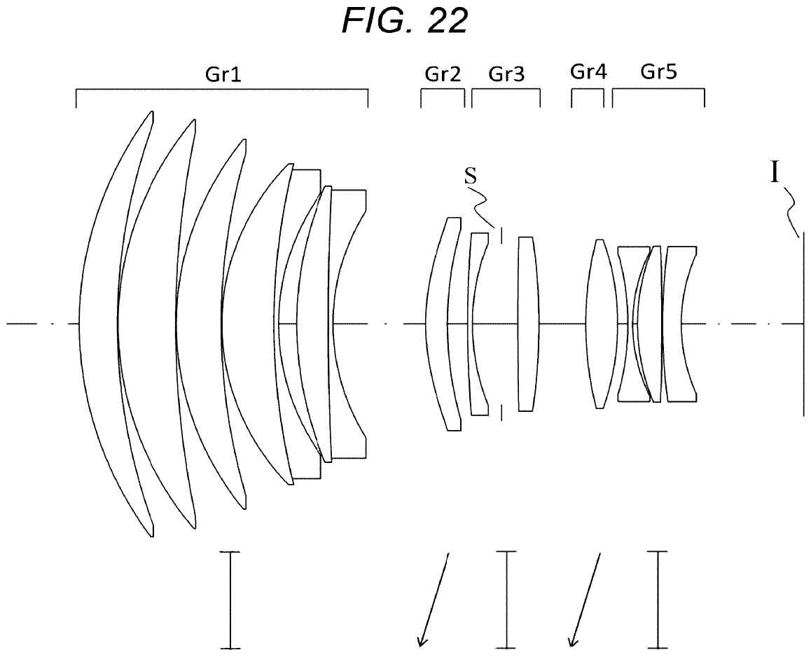

FIG. 22 is a lens configuration diagram of the imaging optical system of Example 4 of the present invention. The system consists of, in order from the object side, a first lens group Gr1 that has a positive refractive power, a second lens group Gr2 that has a positive refractive power, a third lens group Gr3 that has a negative refractive power, a fourth lens group Gr4 that has a positive refractive power, and a fifth lens group Gr5 that has a negative refractive power. During focusing from infinity to a short distance, the second lens group Gr2 and the fourth lens group Gr4 move toward the object side along the same path on the optical axis, and the first lens group Gr1, the third lens group Gr3, and the fifth lens group Gr5 remain stationary with respect to the image surface. The first lens group Gr1 consists of a positive meniscus lens convex toward the object side, a positive meniscus lens convex toward the object side, a positive meniscus lens convex toward the object side, a positive meniscus lens convex toward the object side, a cemented lens of a positive meniscus lens convex toward the object side and a negative meniscus lens convex toward the object side, and a cemented lens of a positive meniscus lens convex toward the object side and a negative meniscus lens convex toward the object side. The second lens group Gr2 consists of a positive meniscus lens whose object side surface is an aspherical surface and convex toward the object side. The third lens group Gr3 consists of a negative meniscus lens convex toward the object side, an aperture diaphragm, and a biconvex lens whose image side surface is an aspherical surface. The fourth lens group Gr4 consists of a biconvex lens. The fifth lens group Gr5 consists of a biconcave lens, a biconvex lens, and a negative meniscus lens convex toward the object side. The second lens group Gr2 has an aspherical surface that weakens a convex power from the center of the optical axis to the periphery. A surface of the third lens group Gr3 closest to the object side is a surface convex toward the object side.

### Example 5

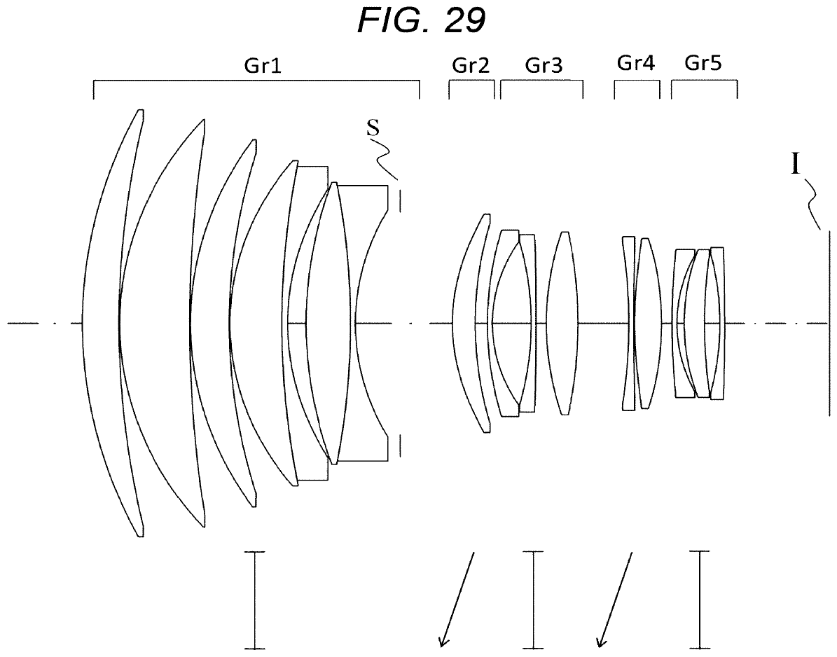

FIG. 29 is a lens configuration diagram of the imaging optical system of Example 5 of the present invention. The imaging lens consists of, in order from the object side, a first lens group Gr1 that has a positive refractive power, an aperture diaphragm, a second lens group Gr2 that has a positive refractive power, a third lens group Gr3 that has a positive refractive power, a fourth lens group Gr4 that has a positive refractive power, and a fifth lens group Gr5 that has a negative refractive power. During focusing from infinity to a short distance, the second lens group Gr2 and the fourth lens group Gr4 move toward the object side along the same path on the optical axis, and the first lens group Gr1, the aperture diaphragm, the third lens group Gr3, and the fifth lens group Gr5 remain stationary with respect to the image surface. The first lens group Gr1 consists of a positive meniscus lens convex toward the object side, a positive meniscus lens convex toward the object side, a positive meniscus lens convex toward the object side, a cemented lens of a positive meniscus lens convex toward the object side and a negative meniscus lens convex toward the object side, and a cemented lens of a biconvex lens and a biconcave lens. The second lens group Gr2 consists of a positive meniscus lens convex toward the object side, of which the object side surface is an aspherical surface. The third lens group Gr3 consists of a negative meniscus lens convex toward the object side, a negative meniscus lens concave toward the object side, and a biconvex lens. The fourth lens group Gr4 consists of a biconcave lens and a biconvex lens of which both surfaces are aspherical. The fifth lens group Gr5 consists of a negative meniscus lens convex toward the object side, a positive meniscus lens convex toward the object side, and a negative meniscus lens concave toward the object side. The second lens group Gr2 has an aspherical surface that weakens a convex power from the center of the optical axis to the periphery. A surface of the third lens group Gr3 closest to the object side is a surface convex toward the object side.

### Example 6

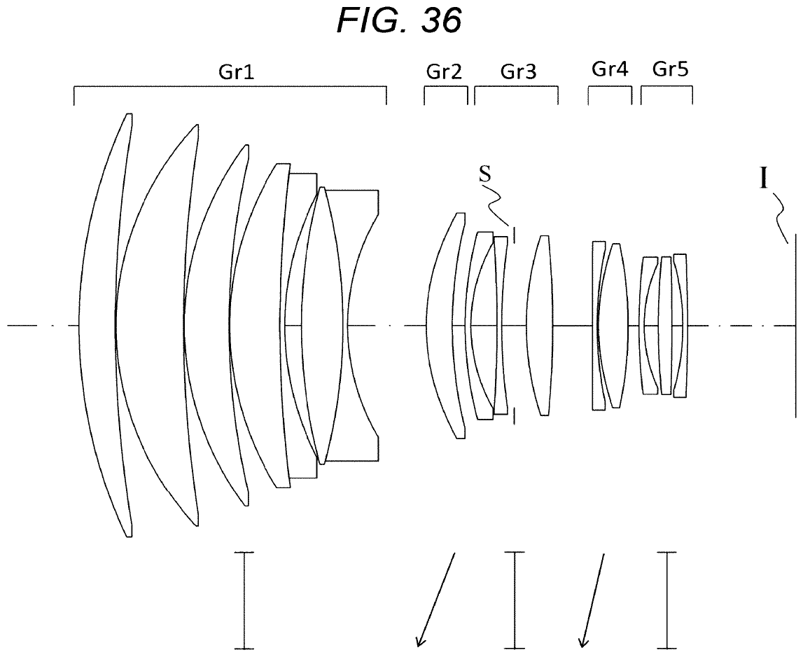

FIG. 36 is a lens configuration diagram of the imaging optical system of Example 6 of the present invention. The system consists of, in order from the object side, a first lens group Gr1 that has a positive refractive power, a second lens group Gr2 that has a positive refractive power, a third lens group Gr3 that has a positive refractive power, a fourth lens group Gr4 that has a positive refractive power, and a fifth lens group Gr5 that has a negative refractive power. During focusing from infinity to a short distance, the second lens group Gr2 and the fourth lens group Gr4 move toward the object side on different paths along the optical axis, and the first lens group Gr1, the third lens group Gr3, and the fifth lens group Gr5 remain stationary with respect to the image surface. The first lens group Gr1 consists of a positive meniscus lens convex toward the object side, a positive meniscus lens convex toward the object side, a positive meniscus lens convex toward the object side, a cemented lens of a positive meniscus lens convex toward the object side and a negative meniscus lens convex toward the object side, and a cemented lens of a biconvex lens and a biconcave lens. The second lens group Gr2 consists of a positive meniscus lens convex toward the object side, in which the object side surface is an aspherical surface. The third lens group Gr3 consists of a negative meniscus lens convex toward the object side, a biconcave lens, an aperture diaphragm, and a biconvex lens. The fourth lens group Gr4 consists of a negative meniscus lens convex toward the object side and a biconvex lens of which both surfaces are aspherical. The fifth lens group Gr5 consists of a negative meniscus lens convex toward the object side, a biconvex lens, and a negative meniscus lens concave toward the object side. The second lens group Gr2 has an aspherical surface that weakens a convex power from the center of the optical axis to the periphery. A surface of the third lens group Gr3 closest to the object side is a surface convex toward the object side.

### Example 7

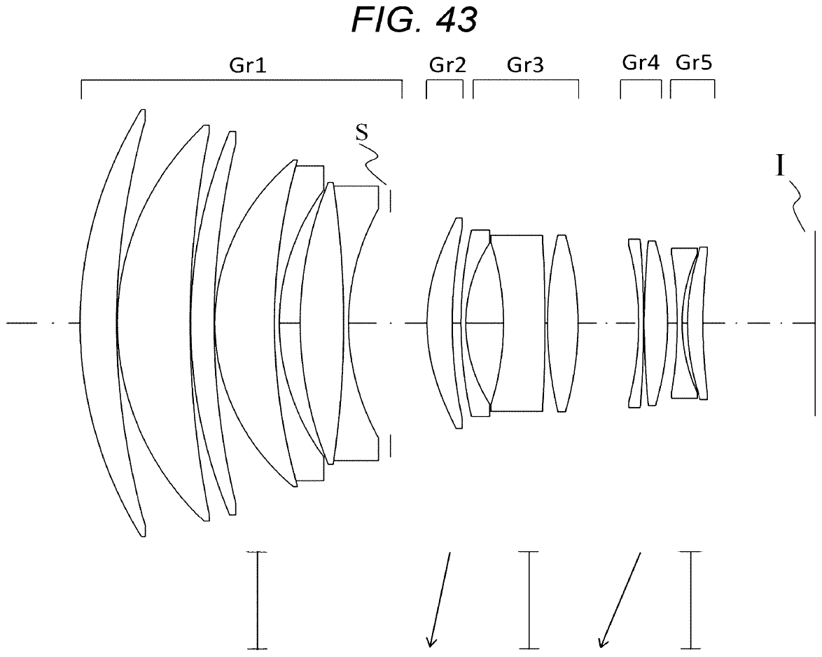

FIG. 43 is a lens configuration diagram of the imaging optical system of Example 7 of the present invention. The system consists of, in order from the object side, a first lens group Gr1 that has a positive refractive power, an aperture diaphragm, a second lens group Gr2 that has a positive refractive power, a third lens group Gr3 that has a positive refractive power, a fourth lens group Gr4 that has a positive refractive power, and a fifth lens group Gr5 that has a negative refractive power. During focusing from infinity to a short distance, the second lens group Gr2 and the fourth lens group Gr4 move toward the object side on different paths along the optical axis, and the first lens group Gr1, the aperture diaphragm, the third lens group Gr3, and the fifth lens group Gr5 remain stationary with respect to an image surface. The first lens group Gr1 consists of a positive meniscus lens that has a surface convex toward the object side, a positive meniscus lens that has a surface convex toward the object side, a positive meniscus lens that has a surface convex toward the object side, a cemented lens of a positive meniscus lens that has a surface convex toward the object side and a negative meniscus lens that has a surface convex toward the object side, and a cemented lens of a biconvex lens and a biconcave lens. The second lens group Gr2 consists of a positive meniscus lens that has a surface convex toward the object side and has a surface that is aspherical. The third lens group Gr3 consists of a negative meniscus lens that has a surface convex toward the object side, a negative meniscus lens that has a surface concave toward the object side, and a biconvex lens. The fourth lens group Gr4 consists of a negative meniscus lens that has a surface concave toward the object side and a biconvex lens of which both surfaces are aspherical. The fifth lens group Gr5 consists of a biconcave lens and a positive meniscus lens that has a surface convex toward the object side. The second lens group Gr2 has an aspherical surface that has a shape that weakens a convex power from the center of the optical axis to the periphery. A surface of the third lens group Gr3 closest to the object side is convex toward the object side.

Specific numerical data of each example of the imaging optical system of the present invention will be shown below.

In [Surface data], the surface number is a number of a lens surface or an aperture diaphragm counted from the object side, r is a curvature radius of each surface, d is a distance between each surface, nd is a refractive index with respect to a d line (587.6 nm), vd is an Abbe number with respect to the d line, and a ray height indicates a maximum ray height.

An asterisk (*) attached to the surface number indicates that the lens surface shape is an aspherical surface shape. In addition, BF represents a back focus.

The (diaphragm) attached to the surface number indicates that the aperture diaphragm is located at that position. In a case of a curvature radius with respect to a plane or an aperture diaphragm, ∞ (infinity) is written.

[Aspherical surface data] shows each coefficient value for giving the aspherical surface shape of the lens surface marked with * in [Surface data]. In a case where a displacement from the optical axis in a direction perpendicular to the optical axis is y, a displacement (sag) from an intersection of the optical axis and the aspherical surface in an optical axis direction is z, a curvature radius of a reference spherical surface is r, a conic coefficient is K, and aspherical coefficients of respective orders are A4, A6, A8, . . . , the shape of the aspherical surface shall be such that the coordinates of the aspherical surface are represented by the following expression.

$$z = \frac{( 1 / r ) {y}^{2}}{1 + \sqrt{1 - ( 1 + K ) {( y / r )}^{2}}} + A 4 {y}^{4} + A 6 {y}^{6} + A 8 {y}^{8} + A 10 {y}^{10} + A 12 {y}^{12} + A 14 {y}^{14}$$

[Various types of data] indicate values such as a focal length in each focusing distance focusing state.

The [Variable distance data] shows the variable distance and the BF value in each focusing distance-focusing state.

The [Lens group data] shows the surface number closest to the object side in each lens group and the total focal length of the entire group.

In addition, in the values of all the specifications described below, unless otherwise noted, the units of the focal length f, the curvature radius r, the lens surface distance d, and other lengths are millimeters (mm), but the present invention is not limited thereto since the same optical performance can be obtained in both the proportional magnification and the proportional reduction in the optical system.

In addition, a list of corresponding values of the conditional expressions in each of these examples is shown.

In addition, in the aberration diagrams corresponding to the respective examples, d, g, and C represent a d-line, a g-line, and a C-line, respectively, and ΔS and ΔM represent a sagittal image surface and a meridional image surface, respectively.

Numerical Example 1
Unit: mm
[Surface data]

| Surface number | r | d | nd | vd | Ray height |
|---|---|---|---|---|---|
| Object surface | ∞ | (d0) | | | |
| 1 | 81.7817 | 5.1730 | 1.75500 | 52.32 | 36.0179 |
| 2 | 121.1430 | 16.1454 | | | 35.3000 |
| 3 | 50.9136 | 14.2120 | 1.55032 | 75.50 | 31.0000 |
| 4 | −984.7552 | 1.4630 | | | 29.9273 |
| 5 | −1352.7590 | 1.5000 | 1.60342 | 38.01 | 28.9821 |
| 6 | 54.0423 | (d6) | | | 26.2081 |
| 7* | 80.1977 | 4.5581 | 1.76450 | 49.09 | 25.3611 |
| 8 | 339.0191 | (d8) | | | 24.9110 |
| 9 | 184.6552 | 5.7128 | 1.94594 | 17.98 | 22.7365 |
| 10 | −106.8076 | 1.0000 | 1.77047 | 29.74 | 22.2931 |
| 11 | 51.0982 | 7.3715 | | | 20.2164 |
| 12 (diaphragm) | ∞ | 4.3989 | | | 19.7000 |
| 13 | −57.8827 | 1.0000 | 1.77047 | 29.74 | 19.5517 |
| 14 | 43.2015 | 9.6152 | 1.59282 | 68.62 | 20.2554 |
| 15 | −85.0308 | 0.1500 | | | 20.5720 |
| 16 | 124.4555 | 5.0500 | 1.85033 | 42.70 | 21.0235 |
| 17 | −173.3377 | 1.0000 | 1.77047 | 29.74 | 20.9742 |
| 18 | 65.5341 | 0.1500 | | | 20.7961 |
| 19 | 57.0673 | 7.0613 | 2.00100 | 29.13 | 20.9566 |
| 20 | −234.4776 | (d20) | | | 20.7500 |
| 21 | 64.8550 | 1.0000 | 1.84666 | 23.78 | 19.1490 |
| 22 | 34.4061 | 1.3816 | | | 18.2044 |
| 23 | 39.2102 | 7.5086 | 1.76450 | 49.09 | 18.2500 |
| 24 | −240.8066 | (d24) | | | 17.6500 |
| 25 | 53.6072 | 3.9554 | 2.00069 | 25.46 | 16.9000 |
| 26 | 190.7008 | 1.0000 | 1.61396 | 44.29 | 16.5346 |
| 27 | 26.2248 | 6.3742 | | | 15.5624 |
| 28* | −462.0252 | 1.0000 | 1.68948 | 31.02 | 15.6163 |
| 29* | 165.8476 | (BF) | | | 15.9500 |
| Image surface | ∞ | | | | |

[Aspherical surface data]

| | Surface 7 | Surface 28 | Surface 29 |
|---|---|---|---|
| K | 0.00000 | 0.00000 | 0.00000 |
| A4 | −1.16535E−06 | −3.38713E−05 | −3.20880E−05 |
| A6 | −2.66879E−10 | 1.55184E−07 | 1.59838E−07 |
| A8 | −2.46526E−14 | −3.92531E−10 | −3.97915E−10 |
| A10 | 2.72744E−17 | 6.51824E−13 | 6.84924E−13 |
| A12 | 0.00000E+00 | −4.79062E−16 | −5.09199E−16 |

[Various types of data]

| | INF | 1812 mm | 858 mm |
|---|---|---|---|
| Focal length | 85.00 | 81.53 | 77.59 |
| F number | 1.24 | 1.25 | 1.30 |
| Total angle of view 2ω | 27.50 | 26.76 | 25.64 |
| Image height Y | 21.63 | 21.63 | 21.63 |
| Total lens length | 152.51 | 152.51 | 152.51 |

[Variable distance data]

| | INF | 1812 mm | 858 mm |
|---|---|---|---|
| d0 | ∞ | 1659.3705 | 705.1536 |
| d6 | 12.5990 | 9.4609 | 5.5314 |
| d8 | 3.2391 | 6.3772 | 10.3067 |
| d20 | 9.3176 | 6.1795 | 2.2500 |
| d24 | 2.1500 | 5.2881 | 9.2176 |
| BF | 17.4271 | 17.4271 | 17.4271 |

[Lens group data]

| Group | Starting surface | Focal length |
|---|---|---|
| Gr1 | 1 | 215.35 |
| Gr2 | 7 | 136.37 |
| Gr3 | 9 | 247.73 |
| Gr4 | 21 | 87.90 |
| Gr5 | 25 | −89.35 |

Numerical Example 2
Unit: mm
[Surface data]

| Surface number | r | d | nd | vd | Ray height |
|---|---|---|---|---|---|
| Object surface | ∞ | (d0) | | | |
| 1 | 79.1309 | 6.575 | 1.66382 | 27.35 | 41.1763 |
| 2 | 133.8544 | 5.7998 | | | 40.7000 |
| 3 | 62.5517 | 10.7918 | 1.55032 | 75.50 | 36.4985 |
| 4 | 294.6036 | 0.1500 | | | 35.8967 |
| 5 | 53.5191 | 11.0666 | 1.59282 | 68.62 | 30.3000 |
| 6 | 747.9162 | 1.1303 | 1.77047 | 29.74 | 29.0283 |
| 7 | 43.7706 | 6.6546 | | | 24.8500 |
| 8 | 191.4283 | 5.0278 | 1.66382 | 27.35 | 24.6914 |
| 9 | −218.3778 | 1.0000 | 1.73800 | 32.33 | 24.2045 |
| 10 | 76.0336 | (d10) | | | 22.9302 |
| 11* | 43.3836 | 4.5511 | 1.80400 | 46.53 | 21.4562 |
| 12 | 84.8457 | (d12) | | | 20.9291 |
| 13 | 113.1599 | 1.0000 | 1.77830 | 23.91 | 19.0387 |
| 14 | 43.4264 | 6.0636 | | | 18.2009 |
| 15 | −92.8706 | 3.9107 | 1.85451 | 25.15 | 18.1766 |
| 16 | −207.8968 | 1.0746 | | | 18.3902 |
| 17 (diaphragm) | ∞ | 1.0226 | | | 18.4000 |
| 18 | 114.3687 | 4.6807 | 1.94594 | 17.98 | 18.5458 |
| 19 | −156.9275 | (d19) | | | 18.5000 |
| 20 | −288.7802 | 1.0000 | 1.75211 | 25.05 | 17.8343 |
| 21 | 49.4861 | 0.5550 | | | 17.4025 |
| 22* | 39.8452 | 8.3926 | 1.75500 | 52.32 | 17.5361 |
| 23* | −65.4186 | (d23) | | | 17.3000 |
| 24 | 68.2724 | 3.2451 | 1.59349 | 67.00 | 4.9500 |
| 25 | 29.9725 | 2.8065 | | | 14.6402 |
| 26 | 70.8942 | 6.9810 | 1.88300 | 40.81 | 14.7866 |
| 27 | 158.9287 | 2.0032 | | | 14.9929 |
| 28 | −123.7443 | 1.0000 | 1.58144 | 40.89 | 15.0491 |
| 29 | 107.0972 | (BF) | | | 15.5000 |
| Image surface | ∞ | | | | |

[Aspherical surface data]

| | Surface 11 | Surface 22 | Surface 23 |
|---|---|---|---|
| K | 0.00000 | 0.00000 | 0.00000 |
| A4 | −1.38193E−06 | −3.69547E−06 | −5.37043E−07 |
| A6 | −1.19813E−09 | −6.60004E−10 | −1.55011E−10 |
| A8 | −8.06729E−13 | −1.47455E−12 | −5.73846E−12 |
| A10 | −3.65881E−16 | −3.80018E−15 | 9.47813E−15 |
| A12 | −8.18903E−19 | 1.52343E−17 | 0.00000E+00 |
| A14 | 1.83170E−22 | 0.00000E+00 | 0.00000E+00 |

[Various types of data]

| | INF | 2214 mm | 1042 mm |
|---|---|---|---|
| Focal length | 105.00 | 98.71 | 91.80 |
| F number | 1.45 | 1.48 | 1.52 |
| Total angle of view 2ω | 22.41 | 21.21 | 19.59 |
| Image height Y | 21.63 | 21.63 | 21.63 |
| Total lens length | 146.00 | 146.00 | 146.00 |

[Variable distance data]

| | INF | 2214 mm | 1042 mm |
|---|---|---|---|
| d0 | ∞ | 2067.5901 | 895.7973 |
| d10 | 15.2045 | 12.2787 | 8.6472 |
| d12 | 3.2331 | 6.1589 | 9.7904 |
| d19 | 8.8073 | 5.8815 | 2.2500 |
| d23 | 2.1500 | 5.0758 | 8.7073 |
| BF | 20.1292 | 20.1292 | 20.1292 |

[Lens group data]

| Group | Starting surface | Focal length |
|---|---|---|
| Gr1 | 1 | 284.86 |
| Gr2 | 11 | 105.27 |
| Gr3 | 13 | 5000.31 |
| Gr4 | 20 | 77.30 |
| Gr5 | 24 | −71.31 |

Numerical Example 3
Unit: mm
[Surface data]

| Surface number | r | d | nd | vd | Ray height |
|---|---|---|---|---|---|
| Object surface | ∞ | (d0) | | | |
| 1 | 114.0643 | 7.5041 | 1.66382 | 27.35 | 45.9500 |
| 2 | 252.1745 | 0.1500 | | | 45.6015 |
| 3 | 67.7795 | 14.1211 | 1.43875 | 94.93 | 43.6500 |
| 4 | 245.0779 | 0.1500 | | | 42.8971 |
| 5 | 73.5506 | 8.2057 | 1.43875 | 94.93 | 39.4841 |
| 6 | 143.7118 | 0.1500 | | | 38.5206 |
| 7 | 58.5797 | 10.3621 | 1.43875 | 94.93 | 34.7548 |
| 8 | 187.9561 | 1.3754 | 1.85451 | 25.15 | 33.5119 |
| 9 | 58.0958 | 3.7476 | | | 30.0319 |
| 10 | 94.4034 | 8.3816 | 1.66382 | 27.35 | 29.9201 |
| 11 | −272.0815 | 1.0000 | 1.73800 | 32.26 | 29.1378 |
| 12 | 51.2279 | 9.3765 | | | 25.6030 |
| 13 (Diaphragm) | ∞ | (d13) | | | 25.0000 |
| 14* | 43.0738 | 5.1201 | 1.77250 | 49.46 | 3.1578 |
| 15 | 84.8457 | (d15) | | | 22.5479 |
| 16 | 66.1135 | 1.0000 | 1.77047 | 29.74 | 19.5976 |
| 17 | 31.3393 | 7.7462 | | | 18.2390 |
| 18 | −94.5286 | 1.0000 | 1.90043 | 37.37 | 18.2275 |
| 19 | 411.7370 | 2.4231 | | | 18.3666 |
| 20 | 74.7282 | 5.9274 | 1.90366 | 31.32 | 18.9500 |
| 21 | −122.0078 | (d21) | | | 18.9000 |
| 22 | −303.0543 | 1.0000 | 1.85896 | 22.73 | 18.0806 |
| 23 | 115.0835 | 0.3799 | | | 17.7907 |
| 24* | 64.4725 | 6.3876 | 1.77250 | 49.50 | 17.7318 |
| 25* | −72.5433 | (d25) | | | 17.5000 |
| 26 | 169.4347 | 1.0000 | 1.66672 | 48.32 | 15.6000 |
| 27 | 36.7527 | 1.8426 | | | 15.4478 |
| 28 | 66.3738 | 3.6525 | 1.92286 | 20.88 | 15.5223 |
| 29 | 742.4879 | 1.7923 | | | 15.5511 |
| 30 | −89.8278 | 1.0000 | 1.56732 | 42.82 | 15.5639 |
| 31 | 103.4361 | (BF) | | | 15.9000 |
| Image surface | ∞ | | | | |

[Aspherical surface data]

| | Surface 14 | Surface 24 | Surface 25 |
|---|---|---|---|
| K | 0.00000 | 0.00000 | 0.00000 |
| A4 | −1.05714E−06 | −2.76045E−06 | −1.01432E−06 |
| A6 | −9.22754E−10 | −8.75009E−10 | −8.32812E−10 |
| A8 | −6.45803E−13 | −1.66203E−12 | −4.90855E−12 |
| A10 | −4.78846E−16 | −4.36014E−15 | 8.10004E−15 |
| A12 | 2.32704E−19 | 1.68876E−17 | 0.00000E+00 |
| A14 | −6.50132E−22 | 0.00000E+00 | 0.00000E+00 |

[Various types of data]

| | INF | 2771 mm | 1282 mm |
|---|---|---|---|
| Focal length | 133.00 | 123.31 | 112.90 |
| F number | 1.45 | 1.46 | 1.50 |
| Total angle of view 2ω | 17.78 | 17.56 | 17.17 |
| Image height Y | 21.63 | 21.63 | 21.63 |
| Total lens length | 152.50 | 152.50 | 152.50 |

[Variable distance data]

| | INF | 2771 mm | 1282 mm |
|---|---|---|---|
| d0 | ∞ | 2618.6850 | 1129.0995 |
| d13 | 9.3354 | 6.2721 | 2.5000 |
| d15 | 2.5000 | 5.5633 | 9.3354 |
| d21 | 9.0853 | 6.0220 | 2.2499 |
| d25 | 2.1500 | 5.2133 | 8.9854 |
| BF | 24.6321 | 24.6321 | 24.6321 |

[Lens group data]

| Group | Starting surface | Focal length |
|---|---|---|
| Gr1 | 1 | 214.03 |
| Gr2 | 14 | 107.51 |
| Gr3 | 16 | −387.83 |
| Gr4 | 22 | 80.79 |
| Gr5 | 26 | −75.01 |

Numerical Example 4
Unit: mm
[Surface data]

| Surface number | r | d | nd | vd | Ray height |
|---|---|---|---|---|---|
| Object surface | ∞ | (d0) | | | |
| 1 | 83.9526 | 8.0282 | 1.66382 | 27.35 | 45.9500 |
| 2 | 140.0505 | 0.1500 | | | 45.4607 |
| 3 | 74.7410 | 12.1489 | 1.43875 | 94.93 | 44.1500 |
| 4 | 227.7552 | 0.1500 | | | 43.4139 |
| 5 | 68.8544 | 9.4283 | 1.43875 | 94.93 | 39.8623 |
| 6 | 147.1059 | 0.1500 | | | 38.9006 |
| 7 | 53.9246 | 10.9297 | 1.43875 | 94.93 | 34.4597 |
| 8 | 160.1278 | 1.0000 | 1.85451 | 25.15 | 33.1552 |
| 9 | 53.7447 | 3.8015 | | | 29.6325 |
| 10 | 84.0041 | 6.7073 | 1.66382 | 27.35 | 29.5176 |
| 11 | 684.8836 | 1.0000 | 1.73800 | 32.26 | 28.6897 |
| 12 | 51.0048 | (d12) | | | 25.7089 |
| 13* | 54.4909 | 4.6191 | 1.77250 | 49.46 | 22.6642 |
| 14 | 84.8457 | (d14) | | | 21.6921 |
| 15 | 275.8994 | 1.0000 | 1.77047 | 29.74 | 19.2678 |
| 16 | 52.7885 | 6.1263 | | | 18.4766 |
| 17 (diaphragm) | ∞ | 3.3642 | | | 18.2000 |
| 18 | 841.4946 | 4.4603 | 1.72916 | 54.67 | 18.3364 |
| 19* | −147.5935 | (d19) | | | 18.3860 |
| 20 | 83.7093 | 6.6947 | 1.59282 | 68.62 | 17.8100 |
| 21 | −61.0515 | (d21) | | | 17.5500 |
| 22 | −62.4613 | 1.0000 | 1.48071 | 85.29 | 15.8000 |
| 23 | 38.4882 | 1.0280 | | | 16.2843 |
| 24 | 48.3879 | 5.1279 | 2.00069 | 25.46 | 16.3955 |
| 25 | −558.2812 | 0.1500 | | | 16.3831 |
| 26 | 140.8781 | 3.9247 | 1.92119 | 23.96 | 16.3272 |
| 27 | 41.1540 | (BF) | | | 15.8500 |
| Image surface | ∞ | | | | |

[Aspherical surface data]

| | Surface 13 | Surface 19 |
|---|---|---|
| K | 0.00000 | 0.00000 |
| A4 | −1.80247E−06 | 5.10070E−08 |
| A6 | −1.28540E−09 | −1.02410E−09 |
| A8 | −6.53623E−13 | 0.00000E+00 |
| A10 | 2.82217E−16 | 0.00000E+00 |
| A12 | −1.63153E−18 | 0.00000E+00 |
| A14 | 1.51001E−21 | 0.00000E+00 |

[Various types of data]

| | INF | 2769 mm | 1269 mm |
|---|---|---|---|
| Focal length | 133.00 | 122.81 | 111.86 |
| F number | 1.45 | 1.49 | 1.57 |
| Total angle of view 2ω | 17.78 | 16.86 | 15.57 |
| Image height Y | 21.63 | 21.63 | 21.63 |
| Total lens length | 152.49 | 152.49 | 152.49 |

[Variable distance data]

| | INF | 2769 mm | 1269 mm |
|---|---|---|---|
| d0 | ∞ | 2616.4494 | 1116.7283 |
| d12 | 19.4355 | 16.0796 | 11.9558 |
| d14 | 4.2443 | 7.6002 | 11.7240 |
| d19 | 9.8797 | 6.5238 | 2.4000 |
| d21 | 2.1500 | 5.5059 | 9.6297 |
| BF | 25.7928 | 25.7928 | 25.7928 |

[Lens group data]

| Group | Starting surface | Focal length |
|---|---|---|
| Gr1 | 1 | 195.23 |
| Gr2 | 13 | 184.90 |
| Gr3 | 15 | −192.49 |
| Gr4 | 20 | 60.59 |
| Gr5 | 22 | −77.07 |

Numerical Example 5
Unit: mm
[Surface data]

| Surface number | r | d | nd | vd | Ray height |
|---|---|---|---|---|---|
| Object surface | ∞ | (d0) | | | |
| 1 | 106.9425 | 7.4447 | 1.66382 | 27.35 | 45.9600 |
| 2 | 213.2896 | 0.1500 | | | 45.5856 |
| 3 | 70.0675 | 14.3114 | 1.43875 | 94.93 | 43.8600 |
| 4 | 306.9637 | 0.1500 | | | 43.1396 |
| 5 | 73.4926 | 7.8901 | 1.43875 | 94.93 | 39.3867 |
| 6 | 136.8930 | 0.1500 | | | 38.4245 |
| 7 | 58.4812 | 10.6384 | 1.43875 | 94.93 | 34.8002 |
| 8 | 203.0591 | 1.1704 | 1.85451 | 25.15 | 33.5623 |
| 9 | 59.5329 | 3.7394 | | | 30.1880 |
| 10 | 97.9408 | 9.0996 | 1.66382 | 27.35 | 30.0758 |
| 11 | −178.7873 | 1.0000 | 1.73800 | 32.26 | 29.3013 |
| 12 | 52.6715 | 9.1420 | | | 25.6012 |
| 13 (Diaphragm) | ∞ | (d13) | | | 25.0000 |
| 14* | 46.1210 | 4.6526 | 1.77250 | 49.50 | 23.0965 |
| 15 | 85.6173 | (d15) | | | 22.5215 |
| 16 | 77.7209 | 1.0000 | 1.76634 | 35.82 | 19.6274 |
| 17 | 34.0563 | 7.9267 | | | 18.4125 |
| 18 | −71.5108 | 1.0000 | 1.79360 | 37.09 | 18.4037 |
| 19 | −668.6210 | 2.0757 | | | 18.6409 |
| 20 | 69.1479 | 6.4650 | 1.88300 | 40.81 | 19.2300 |
| 21 | −108.0194 | (d21) | | | 19.2333 |
| 22 | −130.4860 | 1.0000 | 1.85896 | 22.73 | 18.2640 |
| 23 | 808.9039 | 0.1825 | | | 18.0506 |
| 24* | 101.8941 | 5.4833 | 1.77250 | 49.50 | 17.8709 |
| 25* | −73.4461 | (d25) | | | 17.6200 |
| 26 | 180.4468 | 1.0000 | 1.70154 | 41.24 | 15.5200 |
| 27 | 34.4295 | 1.4699 | | | 15.3660 |
| 28 | 50.4552 | 4.1394 | 1.94594 | 17.98 | 15.4550 |
| 29 | 120.1230 | 3.1342 | | | 15.4371 |
| 30 | −65.6785 | 1.0000 | 1.72000 | 50.30 | 15.4694 |
| 31 | −465.9743 | 21.3909 | | | 15.9000 |
| 32 | ∞ | (BF) | | | |
| Image surface | ∞ | | | | |

[Aspherical surface data]

| | Surface 14 | Surface 24 | Surface 25 |
|---|---|---|---|
| K | 0.00000 | 0.00000 | 0.00000 |
| A4 | −1.01901E−06 | −2.44285E−06 | −8.57110E−07 |
| A6 | −7.94373E−10 | −1.31177E−09 | −1.35030E−09 |
| A8 | −5.11209E−13 | −2.92696E−12 | −2.79238E−12 |
| A10 | −4.67429E−16 | 6.88912E−15 | 1.15676E−14 |
| A12 | 3.80660E−19 | 1.16151E−17 | 0.00000E+00 |
| A14 | −6.38185E−22 | 0.00000E+00 | 0.00000E+00 |

[Various types of data]

| | INF | 2764 mm | 1275 mm |
|---|---|---|---|
| Focal length | 133.00 | 122.21 | 110.97 |
| F number | 1.45 | 1.45 | 1.50 |
| Total angle of view 2ω | 17.81 | 17.66 | 17.33 |
| Image height Y | 21.63 | 21.63 | 21.63 |
| Total lens length | 152.50 | 152.50 | 152.50 |

[Variable distance data]

| | INF | 2764 mm | 1275 mm |
|---|---|---|---|
| d0 | ∞ | 2611.1982 | 1122.1339 |
| d13 | 10.6458 | 6.9650 | 2.5000 |
| d15 | 2.5000 | 6.1808 | 10.6458 |
| d21 | 10.3957 | 6.7149 | 2.2499 |
| d25 | 2.1500 | 5.8308 | 10.2958 |
| BF | 0.0000 | 0.0000 | 0.0000 |

[Lens group data]

| Group | Starting surface | Focal length |
|---|---|---|
| Gr1 | 1 | 211.46 |
| Gr2 | 14 | 123.10 |
| Gr3 | 16 | 901.11 |
| Gr4 | 22 | 94.86 |
| Gr5 | 26 | −66.69 |

Numerical Example 6
Unit: mm
[Surface data]

| Surface number | r | d | nd | vd | Ray height |
|---|---|---|---|---|---|
| Object surface | ∞ | (d0) | | | |
| 1 | 118.8650 | 7.6977 | 1.66382 | 27.35 | 45.9000 |
| 2 | 291.1362 | 0.1500 | | | 45.5589 |
| 3 | 69.0416 | 14.4270 | 1.43875 | 94.93 | 43.5500 |
| 4 | 290.3395 | 0.1500 | | | 42.8224 |
| 5 | 71.1973 | 9.5031 | 1.43875 | 94.93 | 39.0724 |
| 6 | 175.5157 | 0.1500 | | | 38.0765 |
| 7 | 72.3062 | 10.7103 | 1.43875 | 94.93 | 34.8944 |
| 8 | 308.1847 | 1.0177 | 1.85451 | 25.15 | 32.7612 |
| 9 | 68.2856 | 3.5400 | | | 29.8362 |
| 10 | 126.2158 | 8.8556 | 1.66382 | 27.35 | 29.7294 |
| 11 | −126.7621 | 1.0000 | 1.738 | 32.33 | 29.0058 |
| 12 | 52.2529 | (d12) | | | 25.3058 |
| 13* | 49.3640 | 5.6156 | 1.69400 | 56.30 | 24.0543 |
| 14 | 101.8298 | (d14) | | | 23.3223 |
| 15 | 86.7553 | 1.2233 | 1.738 | 32.33 | 19.8959 |
| 16 | 39.8813 | 5.5343 | | | 18.7784 |
| 17 | −300.3071 | 1.0000 | 1.85026 | 32.27 | 18.7389 |
| 18 | 141.6625 | 2.6725 | | | 18.5846 |
| 19 (diaphragm) | ∞ | 2.5644 | | | 18.6000 |
| 20 | 69.1909 | 5.6200 | 1.91082 | 35.25 | 18.9943 |
| 21 | −214.6262 | (d21) | | | 18.8200 |
| 22 | 9352.7762 | 1.0000 | 1.85896 | 22.73 | 17.8200 |
| 23 | 89.6394 | 0.2849 | | | 17.4342 |
| 24* | 53.8557 | 6.2751 | 1.80400 | 43.60 | 17.3216 |
| 25* | −98.8517 | (d25) | | | 16.9500 |
| 26 | 138.3544 | 1.0936 | 1.69560 | 59.00 | 14.3500 |
| 27 | 35.9904 | 2.9919 | | | 14.1023 |
| 28 | 172.9140 | 2.8632 | 1.94594 | 17.98 | 14.2513 |
| 29 | −527.4613 | 2.3216 | | | 14.4273 |
| 30 | −56.4941 | 1.0000 | 1.61997 | 63.88 | 4.5142 |
| 31 | −370.9985 | 23.0598 | | | 15.0000 |
| 32 | ∞ | (BF) | | | |
| Image surface | ∞ | | | | |

[Aspherical surface data]

| | Surface 13 | Surface 24 | Surface 25 |
|---|---|---|---|
| K | 0.00000 | 0.00000 | 0.00000 |
| A4 | −8.72871E−07 | −2.65961E−06 | −9.28202E−07 |
| A6 | −5.65371E−10 | 4.25198E−10 | 2.27225E−09 |
| A8 | −2.35011E−13 | −3.52223E−12 | −1.33333E−11 |
| A10 | 1.52360E−16 | −9.59279E−15 | 2.58645E−14 |
| A12 | −6.97111E−19 | 4.59644E−17 | 0.00000E+00 |
| A14 | 4.34606E−22 | 0.00000E+00 | 0.00000E+00 |

[Various types of data]

| | INF | 2773 mm | 1285 mm |
|---|---|---|---|
| Focal length | 133.00 | 123.42 | 113.05 |
| F number | 1.45 | 1.47 | 1.51 |
| Total angle of view 2ω | 17.78 | 16.64 | 15.15 |
| Image height Y | 21.63 | 21.63 | 21.63 |
| Total lens length | 152.52 | 152.52 | 152.52 |

[Variable distance data]

| | INF | 2773 mm | 1285 mm |
|---|---|---|---|
| d0 | ∞ | 2620.2784 | 1132.3459 |
| d12 | 16.6931 | 12.4095 | 7.2468 |
| d14 | 2.7265 | 7.0101 | 12.1728 |
| d21 | 8.4804 | 5.9489 | 2.6842 |
| d25 | 2.2962 | 4.8277 | 8.0924 |
| BF | 23.0598 | 23.0598 | 23.0598 |

[Lens group data]

| Group | Starting surface | Focal length |
|---|---|---|
| Gr1 | 1 | 230.02 |
| Gr2 | 13 | 132.26 |
| Gr3 | 15 | 1017.10 |
| Gr4 | 22 | 74.19 |
| Gr5 | 26 | −60.33 |

Numerical Example 7
Unit: mm
[Surface data]

| Surface number | r | d | nd | vd | Ray height |
|---|---|---|---|---|---|
| Object surface | ∞ | (d0) | | | |
| 1 | 96.8670 | 7.5597 | 1.66382 | 27.35 | 45.9500 |
| 2 | 176.2446 | 0.1500 | | | 45.5324 |
| 3 | 63.8928 | 15.1403 | 1.43875 | 94.93 | 43.6500 |
| 4 | 234.5141 | 0.1500 | | | 42.8104 |
| 5 | 119.1073 | 4.8292 | 1.43875 | 94.93 | 41.1615 |
| 6 | 184.4604 | 0.1500 | | | 40.3141 |
| 7 | 49.5240 | 12.3575 | 1.43875 | 94.93 | 34.8832 |
| 8 | 144.3872 | 1.0000 | 1.85451 | 25.15 | 33.5951 |
| 9 | 53.3286 | 4.3697 | | | 30.1015 |
| 10 | 89.2734 | 8.9963 | 1.66382 | 27.35 | 29.9898 |
| 11 | −230.1887 | 1.0000 | 1.73800 | 32.26 | 29.1900 |
| 12 | 56.6885 | 8.6784 | | | 25.7355 |
| 13 (Diaphragm) | ∞ | (d13) | | | 25.0000 |
| 14* | 44.1693 | 5.2002 | 1.77250 | 49.50 | 22.2297 |
| 15 | 112.5396 | (d15) | | | 21.5332 |
| 16 | 103.0082 | 1.0000 | 1.76634 | 35.82 | 19.6330 |
| 17 | 35.7770 | 7.7803 | | | 18.1763 |
| 18 | −65.2364 | 8.6272 | 1.85478 | 24.80 | 18.1272 |
| 19 | −363.1647 | 0.5259 | | | 18.4809 |
| 20 | 93.4173 | 6.2737 | 1.88300 | 40.81 | 18.5712 |
| 21 | −77.5198 | (d21) | | | 18.4000 |
| 22 | −76.4916 | 1.0000 | 1.75211 | 25.05 | 17.6700 |
| 23 | −270.2897 | 0.1500 | | | 17.5046 |
| 24* | 171.8958 | 4.8258 | 1.77250 | 49.50 | 17.2592 |
| 25* | −69.9672 | (d25) | | | 17.0000 |
| 26 | −102.2467 | 1.0000 | 1.69560 | 59.00 | 15.3500 |
| 27 | 40.2915 | 1.1270 | | | 15.6912 |
| 28 | 55.4724 | 3.3258 | 1.94594 | 17.98 | 15.8144 |
| 29 | 138.1347 | (BF) | | | 15.9500 |
| Image surface | ∞ | | | | |

[Aspherical surface data]

| | Surface 14 | Surface 24 | Surface 25 |
|---|---|---|---|
| K | 0.00000 | 0.00000 | 0.00000 |
| A4 | −1.66299E−06 | −1.90483E−06 | −5.93174E−07 |
| A6 | −1.33853E−09 | −6.56929E−10 | −2.15703E−09 |
| A8 | −8.63305E−13 | 4.38309E−12 | 1.03719E−11 |
| A10 | −3.33247E−16 | 1.54553E−14 | 2.82855E−15 |
| A12 | −8.50612E−19 | −5.61325E−18 | 0.00000E+00 |
| A14 | 7.42169E−22 | 0.00000E+00 | 0.00000E+00 |

[Various types of data]

| | INF | 2726 mm | 1248 mm |
|---|---|---|---|
| Focal length | 133.00 | 121.57 | 110.27 |
| F number | 1.45 | 1.46 | 1.51 |
| Total angle of view 2ω | 17.78 | 17.81 | 17.60 |
| Image height Y | 21.63 | 21.63 | 21.63 |
| Total lens length | 152.50 | 152.50 | 152.50 |

[Variable distance data]

| | INF | 2726 mm | 1248 mm |
|---|---|---|---|
| d0 | ∞ | 2573.6510 | 1095.7259 |
| d13 | 7.6819 | 5.4051 | 2.5000 |
| d15 | 1.8000 | 4.0768 | 6.9819 |
| d21 | 12.6199 | 7.5280 | 2.0000 |
| d25 | 2.0000 | 7.0919 | 12.6199 |
| BF | 23.1826 | 23.1826 | 23.1826 |

[Lens group data]

| Group | Starting surface | Focal length |
|---|---|---|
| Gr1 | 1 | 190.91 |
| Gr2 | 14 | 91.10 |
| Gr3 | 16 | 902.81 |
| Gr4 | 22 | 115.21 |
| Gr5 | 26 | −73.04 |

[Conditional expression corresponding value]

| | Example | | | | | | |
|---|---|---|---|---|---|---|---|
| Conditional Expression | ex1 | ex2 | ex3 | ex4 | ex5 | ex6 | ex7 |
| (1) | 0.63 | 0.37 | 0.50 | 0.95 | 0.58 | 0.57 | 0.48 |
| (2) | 1.32 | 1.20 | 1.28 | 1.27 | 1.26 | 1.35 | 1.26 |
| (3) | 3.24 | 3.23 | 2.50 | 4.24 | 2.50 | 2.73 | 1.80 |
| (4) | 0.46 | 0.46 | 0.66 | 0.69 | 0.70 | 0.74 | 0.87 |
| (5) | 1.30 | 1.58 | 1.79 | 1.78 | 1.79 | 1.83 | 1.78 |
| (6) | 1.06 | 1.14 | 1.34 | 1.50 | 1.13 | 1.12 | 1.25 |
| (7) | 1.33 | 1.77 | 2.12 | 1.92 | 1.75 | 2.03 | 2.07 |
| (8) | 1.19 | 1.30 | 1.36 | 1.34 | 1.36 | 1.46 | 1.36 |
| (9) | 1.00 | 1.00 | 1.00 | 1.00 | 1.00 | 1.63 | 0.49 |
| (10) | 0.67 | 0.64 | 0.67 | 0.51 | 0.74 | 0.65 | 0.83 |
| (11) | 2.00 | 1.95 | 1.90 | 1.73 | 1.88 | 1.91 | 1.88 |

Further, the aperture diaphragm S may be disposed in the first lens group Gr1 or may be disposed between the second lens group Gr2 and the third lens group Gr3.

In addition, although not described in Examples, a hybrid aspherical surface, a diffraction grating, a refractive index distribution lens, or the like may be used as the lens element to reduce the size or improve the performance. The shape of the aspherical surface may also have an inflection point and may be a gullwing shape or may be a free curved surface.

In addition, although Examples describe the refractive index and the Abbe number, the present invention is not limited to numerical ranges thereof, and a material having a refractive index nd of 1.43 or less or 2.01 or more may be used, and a material having an Abbe number vd of 17.0 or less or 101.0 or more may be used.

In addition, a material having a feature not described in Examples may be used for downsizing, weight reduction, and favorable aberration correction. A small drive for focusing may be performed using a liquid lens or a gel lens.

In addition, in Examples, a part or the whole of the lens group may be moved in a direction substantially perpendicular to the optical axis to have the action of the vibration-proofing.

### DESCRIPTION OF REFERENCE NUMERALS AND SIGNS

Gr1: first lens group
Gr2: second lens group
Gr3: third lens group
Gr4: fourth lens group
Gr5: fifth lens group
I: image surface
S: aperture diaphragm

What is claimed is:

1. An imaging optical system comprising, in order from an object side: a first lens group Gr1; a second lens group Gr2 that has a positive refractive power; a third lens group Gr3; a fourth lens group Gr4 that has a positive refractive power; and a fifth lens group Gr5 that has a negative refractive power, wherein
during focusing from infinity to a short distance, the second lens group Gr2 and the fourth lens group Gr4 move toward the object side along an optical axis, and
a following conditional expression is satisfied,
$$0.20 < f 2 / f 1 < 1.5 \qquad ( 1 )$$
f2: a focal length of the second lens group Gr2
f1: a focal length of the first lens group Gr1.

2. The imaging optical system according to claim 1, wherein
a maximum ray height in the second lens group Gr2 is higher than a maximum ray height in the fourth lens group Gr4, and
a following conditional expression is satisfied,
$$1. < YGr 2 / YGr 4 < 3. \qquad ( 2 )$$
YGr2: a maximum ray height in the second lens group Gr2
YGr4: a maximum ray height in the fourth lens group Gr4.

3. The imaging optical system according to claim 1, wherein
a following conditional expression is satisfied,
$$0.30 < LGr 2 / LGr 4 < 2.50 \qquad ( 4 )$$
LGr2: a length of the second lens group Gr2 on an optical axis
LGr4: a length of the fourth lens group Gr4 on an optical axis.

4. The imaging optical system according to claim 1, wherein
the first lens group Gr1 includes a lens component having a positive refractive power and a surface convex toward the object side at a position closest to the object side.

5. The imaging optical system according to claim 1, wherein
an on-axis ray height at a lens surface closest to the object side in the first lens group Gr1 during focusing on infinity is higher than an on-axis ray height at a lens surface closest to an image side in the first lens group Gr1 during focusing on infinity, and
a following conditional expression is satisfied,
$$1. < YGr 1 F / YGr 1 R < 4. \qquad ( 5 )$$
YGr1F: an on-axis ray height at a lens surface closest to the object side in the first lens group Gr1 during focusing on infinity
YGr1R: an on-axis ray height at a lens surface closest to an image side in the first lens group Gr1 during focusing on infinity.

6. The imaging optical system according to claim 1, wherein the first lens group Gr1 includes one or more lenses having a negative refractive power.

7. The imaging optical system according to claim 1, wherein the second lens group Gr2 consists of one lens.

8. The imaging optical system according to claim 1, wherein the second lens group Gr2 consists of one aspherical lens.

9. The imaging optical system according to claim 1, wherein
a following conditional expression is satisfied,
$$0.80 < β3 < 2. \qquad ( 6 )$$
ß3: a lateral magnification of the third lens group Gr3 during focusing on infinity.

10. The imaging optical system according to claim 1, wherein
a following conditional expression is satisfied,
$$0.80 < K 2 + K 4 < 4.00 \qquad ( 7 )$$
K2: a focus sensitivity of the second lens group Gr2 during focusing on infinity
K4: a focus sensitivity of the fourth lens group Gr4 during focusing on infinity where, the focus sensitivity K2 is K2=(1-ß2\hat{ }2)*(ß345 2), ß2 is a lateral magnification of the second lens group Gr2 during focusing on infinity, and ß345 is a combined lateral magnification of the third lens group Gr3 and subsequent groups during focusing on infinity,
where, the focus sensitivity K4 is K4=(1·261 4\hat{ }2)*(ß5\hat{ }2), ß4 is a lateral magnification of the fourth lens group Gr4 during focusing on infinity, and ß5 is a lateral magnification of the fifth lens group Gr5 during focusing on infinity.

11. The imaging optical system according to claim 1, wherein
following conditional expressions are satisfied,
$$1. < β5 < 1.9 \qquad ( 8 )$$
$$0.3 < Δ xGr 2 / Δ xGr 4 < 2.5 \qquad ( 9 )$$
$$0.3 < β4 < 0.95 \qquad ( 10 )$$
ß5: a lateral magnification of the fifth lens group Gr5 during focusing on infinity
ΔxGr2: a movement amount of the second lens group Gr2 during focusing from infinity to a short distance
ΔxGr4: a movement amount of the fourth lens group Gr4 during focusing from infinity to a short distance
ß4: a lateral magnification of the fourth lens group Gr4 during focusing on infinity.

12. An imaging optical system comprising, in order from an object side: a first lens group Gr1; a second lens group Gr2 that has a positive refractive power; a third lens group Gr3; a fourth lens group Gr4 that has a positive refractive power; and a fifth lens group Gr5 that has a negative refractive power, wherein
during focusing from infinity to a short distance, the second lens group Gr2 and the fourth lens group Gr4 move toward the object side along an optical axis,
a maximum ray height in the second lens group Gr2 is higher than a maximum ray height in the fourth lens group Gr4, and
a following conditional expression is satisfied,
$$1. < YGr 2 / YGr 4 < 3. \qquad ( 2 )$$
YGr2: a maximum ray height in the second lens group Gr2
YGr4: a maximum ray height in the fourth lens group Gr4.

13. The imaging optical system according to claim 12, wherein
a lens surface closest to the object side in the third lens group Gr3 is a surface convex toward the object side, and
a following conditional expression is satisfied,
$$1.10 < dGr 23 / dL min \qquad ( 3 )$$
dGr23: a length on an optical axis from a surface of the second lens group Gr2 closest to an image side to a surface of the third lens group Gr3 closest to the object side during focusing on infinity
dLmin: a length on an optical axis of a lens having a shortest length on an optical axis (where, a length of an optical element formed of cement having an effect of aberration correction of a compound aspherical surface, a diffraction element, or the like is excluded).

14. The imaging optical system according to claim 12, wherein a following conditional expression is satisfied,
$$0.3 < LGr 2 / LGr 4 < 2.50 \qquad ( 4 )$$
LGr2: a length of the second lens group Gr2 on an optical axis
LGr4: a length of the fourth lens group Gr4 on an optical axis.

15. The imaging optical system according to claim 12, wherein
the first lens group Gr1 includes a lens component having a positive refractive power and a surface convex toward the object side at a position closest to the object side.

16. The imaging optical system according to claim 12, wherein
an on-axis ray height at a lens surface closest to the object side in the first lens group Gr1 during focusing on infinity is higher than an on-axis ray height at a lens surface closest to an image side in the first lens group Gr1 during focusing on infinity, and
a following conditional expression is satisfied,
$$1. < YGr 1 F / YGr 1 R < 4. \qquad ( 5 )$$
YGr1F: an on-axis ray height at a lens surface closest to the object side in the first lens group Gr1 during focusing on infinity
YGr1R: an on-axis ray height at a lens surface closest to an image side in the first lens group Gr1 during focusing on infinity.

17. The imaging optical system according to claim 12, wherein the first lens group Gr1 includes one or more lenses having a negative refractive power.

18. The imaging optical system according to claim 12, wherein the second lens group Gr2 consists of one lens.

19. The imaging optical system according to claim 12, wherein the second lens group Gr2 consists of one aspherical lens.

20. The imaging optical system according to claim 12, wherein
a following conditional expression is satisfied,
$$0.8 < β3 < 2. \qquad ( 6 )$$
ß3: a lateral magnification of the third lens group Gr3 during focusing on infinity.

21. The imaging optical system according to claim 12, wherein
a following conditional expression is satisfied,
$$0.80 < K 2 + K 4 < 4.00 \qquad ( 7 )$$
K2: a focus sensitivity of the second lens group Gr2 during focusing on infinity
K4: a focus sensitivity of the fourth lens group Gr4 during focusing on infinity
where, the focus sensitivity K2 is K2=(1·ß2\hat{ }2)*(ß345\hat{ }3), ß2 is a lateral magnification of the second lens group Gr2 during focusing on infinity, and ß345 is a combined lateral magnification of the third lens group Gr3 and subsequent groups during focusing on infinity,
where, the focus sensitivity K4 is K4=(1·ß4\hat{ }2)*(focusinß5\hat{ }2), ß4 is a lateral magnification of the fourth lens group Gr4 during focusing on infinity, and ß5 is a lateral magnification of the fifth lens group Gr5 during focusing on infinity.

22. The imaging optical system according to claim 12, wherein
following conditional expressions are satisfied,
$$1. < β5 < 1.9 \qquad ( 8 )$$
$$0.3 < Δ xGr 2 / Δ xGr 4 < 2.5 \qquad ( 9 )$$
$$0.3 < β4 < 0.95 \qquad ( 10 )$$
ß5: a lateral magnification of the fifth lens group Gr5 during focusing on infinity
ΔxGr2: a movement amount of the second lens group Gr2 during focusing from infinity to a short distance
ΔxGr4: a movement amount of the fourth lens group Gr4 during focusing from infinity to a short distance
ß4: a lateral magnification of the fourth lens group Gr4 during focusing on infinity.

23. An imaging optical system comprising, in order from an object side: a first lens
group Gr1; a second lens group Gr2 that has a positive refractive power; a third lens
group Gr3; a fourth lens group Gr4 that has a positive refractive power; and a fifth lens
group Gr5 that has a negative refractive power, wherein
during focusing from infinity to a short distance, the second lens group Gr2 and the fourth lens group Gr4 move toward the object side along a same path on an optical axis.
